(19) United States
(12) Patent Application Publication
(10) Pub. No.: US 2024/0027199 A1
(43) Pub. Date: Jan. 25, 2024

(54) ADAPTIVE ELECTRIC VEHICLE (EV) SCHEDULING

(71) Applicants: Amit Kumar, Sugar Land, TX (US); Nishant Mehta, Delhi (IN); Piyush Manocha, New Delhi (IN); Anshul Gupta, Delhi (IN); Naveen Sankaran, Chennai (IN); Anshul Anand, Lucknow (IN); Sri Krishnan Narayanan, Singapore (MY); Dharmesh Kumar, Gaya (IN); Raffaele Menolascino, Torino (IT)

(72) Inventors: Amit Kumar, Sugar Land, TX (US); Nishant Mehta, Delhi (IN); Piyush Manocha, New Delhi (IN); Anshul Gupta, Delhi (IN); Naveen Sankaran, Chennai (IN); Anshul Anand, Lucknow (IN); Sri Krishnan Narayanan, Singapore (MY); Dharmesh Kumar, Gaya (IN); Raffaele Menolascino, Torino (IT)

(21) Appl. No.: 18/081,615

(22) Filed: Dec. 14, 2022

(30) Foreign Application Priority Data
Jul. 18, 2022 (EP) 22425030.8

(51) Int. Cl. G01C 21/34; B60L 58/12; G06Q 10/083; G07C 5/00

(52) U.S. Cl. CPC G01C 21/3407; G01C 21/3469; B60L 58/12; G06Q 10/083; G07C 5/006

(57) ABSTRACT

Aspects of the present disclosure provide methods, devices, and computer-readable storage media that support adaptive scheduling of electric vehicles (EVs) of an EV fleet for order deliveries. In some implementations, one or more aspects of the adaptive EV scheduling may be customized for EVs. For example, the adaptive EV scheduling may include identifying an energy efficient route that also reduces stress on a battery of an EV and may be based at least in part on a charging parameter associated with the EV. In some examples, the charging parameter may include one or more of a state of charge (SOC) associated with the battery, a state of health (SOH) associated with the battery, a location of a charging station for the EV, an average charging duration associated with the EV, or an intelligent charging parameter associated with the EV.

### CROSS-REFERENCE TO RELATED APPLICATIONS

The present claims the benefit of priority from European Patent Application No. 22425030.8 filed Jul. 18, 2022 and entitled “ADAPTIVE ELECTRIC VEHICLE (EV) SCHEDULING,” the disclosure of which is incorporated by reference herein in its entirety.

### TECHNICAL FIELD

The present disclosure relates generally to electronic devices, and more particularly, to adaptive electric vehicle (EV) scheduling by electronic devices.

### BACKGROUND

Goods are shipped using a variety of transportation techniques. For example, goods may be shipped using one or more of a truck, a train, an airplane, a seaborne vessel, or another shipping modality. In many cases, delivery of goods on time is important to the shipping party and to the purchasing party. For example, the value of perishable goods may be diminished if such goods arrive late (e.g., due to weather, traffic, or other conditions). Further, many purchasing parties may use a “just in time” (JIT) workflow to attempt to reduce storage fees and other costs. In such cases, a delay in the delivery of goods (such as industrial materials of other goods) might introduce a bottleneck condition, result in spoilage (e.g., for perishable goods), or interrupt manufacturing or other operations.

To try to reduce or avoid shipping delays, shipping parties may use a variety of data to attempt to plan shipments. Some systems may plan shipments by identifying a shortest distance or fastest path between a pickup location and a drop-off location. Such techniques may be inefficient in some cases, such as where weather, traffic, or other events disrupt one or more shipments.

Other systems may use a more complex algorithm that plans a shipment by attempting to optimize multiple variables, such as by selecting a shipment route or shipment modality that reduces exposure to inclement weather conditions and traffic while also reducing fuel expenditure and delivery time (e.g., by attempting to achieve a trade-off between fuel expenditure and delivery time). Such techniques may still, in some cases, be subject to shipment delays (e.g., where delivery time is increased in favor of reduced fuel expenditure) and may also be associated with a relatively poor sustainability metric (e.g., where fuel expenditure is increased to reduce delivery time).

### SUMMARY

Aspects of the present disclosure provide methods, devices, and computer-readable storage media that support adaptive scheduling of electric vehicles (EVs) of an EV fleet for order deliveries or other purposes. In some implementations, one or more aspects of the adaptive EV scheduling may be customized for EVs. For example, the adaptive EV scheduling may include identifying an energy efficient route that also reduces stress on a battery of an EV and may be based at least in part on one or more charging parameters associated with the EV. In some examples, the one or more charging parameters may include one or more of a state of charge (SOC) associated with the battery, a state of health (SOH) associated with the battery, a location of a charging station for the EV, an average charging duration associated with the EV, or an intelligent charging parameter associated with the EV (e.g., an amount of charging to be performed for the EV based on a particular order).

In some aspects of the disclosure, an adaptive EV scheduling engine uses a “phased” EV scheduling process that prioritizes orders in a first phase, prioritizes vehicles in a second phase after the first phase, and maps the prioritized vehicles to the prioritized orders in a third phase after the second phase. To illustrate, the adaptive EV scheduling engine may receive order data indicating orders for shipping of goods to be performed by at least some vehicles of the EV fleet. The order data may indicate order parameters, such as volume of goods, weight of goods, or one or more service level agreements (SLAs) (such as delivery time), as illustrative examples. The adaptive EV scheduling engine may prioritize the orders based on the order parameters. The adaptive EV scheduling engine may further receive vehicle data indicating vehicle parameters of the EV fleet, such as vehicle range, vehicle type, trailer size, battery status, utilization ratio and maintenance schedule. The adaptive EV scheduling engine may prioritize vehicles of the EV fleet based on the vehicle parameters. After prioritizing the orders and the vehicles, the adaptive EV scheduling engine may perform vehicle-to-order mapping to assign the prioritized orders to the prioritized vehicles.

In some examples, the adaptive EV scheduling engine may perform one or both of the vehicle prioritization or the vehicle-to-order mapping based on one or more EV charging parameters. As an illustrative example, during the vehicle-to-order mapping, the adaptive EV scheduling engine may select a vehicle for a particular order based on an SOH and SOC of the vehicle, such as based on a determination that an order distance associated with the particular order is within a particular charging metric associated with the vehicle (e.g., a product of the SOH and SOC).

By planning shipping operations based on charging parameters, energy expenditure may be reduced, resulting in increased sustainability. To illustrate, assigning EVs to orders based on locations of charging stations may decrease an amount of time and distance traveled by an EV to a charging station, reducing road time, energy expenditure, and delivery latency in some instances. As a result, metrics such as cost and delivery time may be reduced while also reducing resource consumption (e.g., energy expenditure) and also increasing sustainability in a shipping system.

In some implementations, the EV scheduling process may include one or more additional phases, such as a phase that includes receiving feedback data associated with performance of the orders. The adaptive EV scheduling engine may use the feedback data in one or more subsequent scheduling operations. In some examples, the feedback data may indicate one or more of a loading time, an unloading time, an average wait time during loading, an average wait time during unloading, a customer rating, a historical delay, fleet manager feedback, an average charging time, an SOC after charging, or vehicle operational behavior (such as a type of braking or acceleration). In some examples, use of the feedback data may increase adaptiveness of the EV scheduling process and may enable dynamic operation of the adaptive EV scheduling engine.

In some aspects, the adaptive EV scheduling may be performed autonomously (or with “zero touch” operation). For example, in some implementations, EV scheduling may be performed automatically and without input from a fleet manager. As a result, error and bias that may be associated with human intervention in the EV scheduling process may be reduced or eliminated in some implementations.

In a particular aspect, a method for adaptive EV scheduling includes receiving, by one or more processors, order data from an order management system and receiving, by the one or more processors, vehicle data from a fleet management system. The order data indicates a plurality of deliveries, and the vehicle data indicates vehicle parameters associated with a plurality of EVs that are included in an EV fleet. The method further includes automatically generating, by the one or more processors, vehicle-to-order scheduling data based on the order data, the vehicle data, and one or more EV charging parameters associated with at least one EV of the plurality of EVs. The vehicle-to-order scheduling data indicates a mapping of the plurality of deliveries to the plurality of EVs. The method further includes initiating transmission, by the one or more processors, of the vehicle-to-order scheduling data to initiate dispatch of the plurality of EVs for performance of the plurality of deliveries. The method further includes receiving, by the one or more processors, feedback data based on the performance of the plurality of deliveries. The method further includes performing, by the one or more processors, one or more operations based on the feedback data.

In another particular aspect, an apparatus for adaptive EV scheduling includes a memory and one or more processors communicatively coupled to the memory. The one or more processors are configured to receive order data from an order management system and to receive vehicle data from a fleet management system. The order data indicates a plurality of deliveries, and the vehicle data indicates vehicle parameters associated with a plurality of EVs that are included in an EV fleet. The one or more processors are further configured to automatically generate vehicle-to-order scheduling data based on the order data, the vehicle data, and one or more EV charging parameters associated with at least one EV of the plurality of EVs. The vehicle-to-order scheduling data indicates a mapping of the plurality of deliveries to the plurality of EVs. The one or more processors are further configured to initiate transmission of the vehicle-to-order scheduling data to initiate dispatch of the plurality of EVs for performance of the plurality of deliveries. The one or more processors are further configured to receive feedback data based on the performance of the plurality of deliveries. The one or more processors are further configured to perform one or more operations based on the feedback data.

In another particular aspect, a non-transitory computer-readable storage medium storing instructions that, when executed by one or more processors, cause the one or more processors to perform operations for adaptive EV scheduling is provided. The operations include receiving, by the one or more processors, order data from an order management system and receiving, by the one or more processors, vehicle data from a fleet management system. The order data indicates a plurality of deliveries, and the vehicle data indicates vehicle parameters associated with a plurality of EVs that are included in an EV fleet. The operations further include automatically generating, by the one or more processors, vehicle-to-order scheduling data based on the order data, the vehicle data, and one or more EV charging parameters associated with at least one EV of the plurality of EVs. The vehicle-to-order scheduling data indicates a mapping of the plurality of deliveries to the plurality of EVs. The operations further include initiating transmission, by the one or more processors, of the vehicle-to-order scheduling data to initiate dispatch of the plurality of EVs for performance of the plurality of deliveries. The operations further include receiving, by the one or more processors, feedback data based on the performance of the plurality of deliveries. The operations further include performing, by the one or more processors, one or more operations based on the feedback data.

The foregoing has outlined rather broadly the features and technical advantages of the present disclosure in order that the detailed description that follows may be better understood. Additional features and advantages will be described hereinafter which form the subject of the claims of the disclosure. It should be appreciated by those skilled in the art that the conception and specific aspects disclosed may be readily utilized as a basis for modifying or designing other structures for carrying out the same purposes of the present disclosure. It should also be realized by those skilled in the art that such equivalent constructions do not depart from the scope of the disclosure as set forth in the appended claims. The novel features which are disclosed herein, both as to organization and method of operation, together with further objects and advantages will be better understood from the following description when considered in connection with the accompanying figures. It is to be expressly understood, however, that each of the figures is provided for the purpose of illustration and description only and is not intended as a definition of the limits of the present disclosure.

### BRIEF DESCRIPTION OF THE DRAWINGS

For a more complete understanding of the present disclosure, reference is now made to the following descriptions taken in conjunction with the accompanying drawings, in which:

FIG. 1 is a block diagram illustrating an example of a system that supports adaptive EV scheduling according to one or more aspects of the disclosure.

FIG. 2 is a flow diagram illustrating an example of a method that supports EV scheduling according to one or more aspects of the disclosure.

FIG. 3 is a diagram illustrating an example of an order classification engine according to one or more aspects of the disclosure.

FIG. 4 is a diagram illustrating an example of a vehicle classification and order provisioning engine according to one or more aspects of the disclosure.

FIG. 5 is a diagram illustrating an example of a vehicle order mapping engine according to one or more aspects of the disclosure.

FIG. 6 is a diagram illustrating examples of an artificial intelligence (AI)-based factor recalibration engine and a reverse logistics engine according to one or more aspects of the disclosure.

FIG. 7 is a flow diagram illustrating an example of a method that supports EV scheduling according to one or more aspects of the disclosure.

It should be understood that the drawings are not necessarily to scale and that the disclosed aspects are sometimes illustrated diagrammatically and in partial views. In certain instances, details that are not necessary for an understanding of the disclosed methods and apparatuses, or which render other details difficult to perceive, may have been omitted. It should be understood, of course, that this disclosure is not limited to the particular aspects illustrated herein.

### DETAILED DESCRIPTION

Some aspects of the present disclosure support adaptive scheduling of electric vehicles (EVs) of an EV fleet for order deliveries or other purposes. In some implementations, one or more aspects of the adaptive EV scheduling may be “tailored” or customized for EVs, which may reduce cost (e.g., by reducing fuel consumption and travel time) while increasing sustainability. For example, the adaptive EV scheduling may include identifying an energy efficient route that also reduces stress on a battery of an EV. The energy efficient route may be selected based at least in part on one or more charging parameters associated with the EV, such as one or more of a state of charge (SOC) associated with a battery of the EV, a state of health (SOH) associated with the battery, a location of a charging station for the EV, an average charging duration associated with the EV, or an intelligent charging parameter associated with the EV (e.g., an amount of charging to be performed for the EV based on a particular order).

By planning shipping operations based on charging parameters, energy expenditure may be reduced, resulting in increased sustainability, and/or optimized, resulting in more deliveries per unit of energy expenditure. To illustrate, assigning EVs to orders based on locations of charging stations may decrease an amount of time and distance traveled by an EV to a charging station, reducing road time, energy expenditure, and delivery latency in some instances. As a result, metrics such as cost and delivery time may be reduced while also reducing resource consumption (e.g., energy expenditure) and also increasing sustainability in a shipping system.

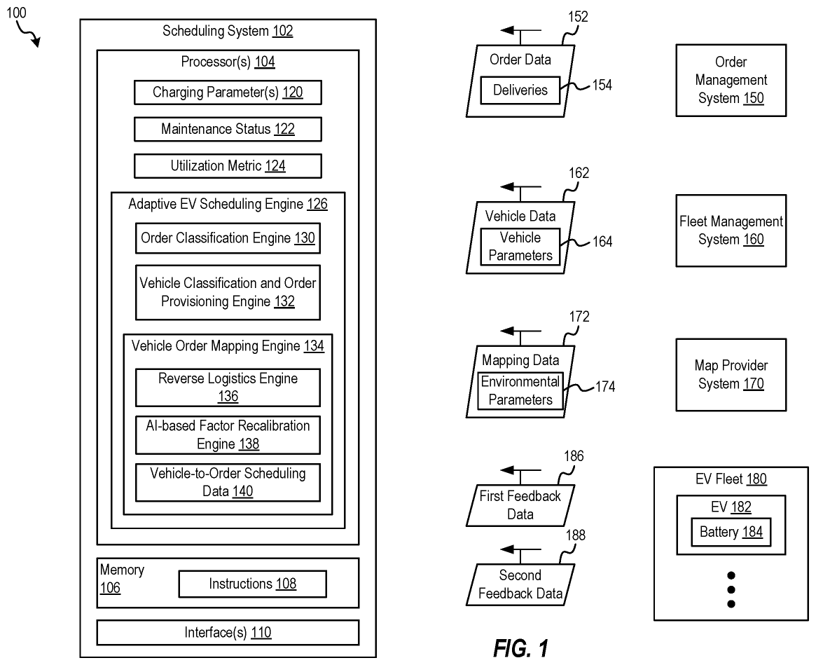

FIG. 1 is a block diagram illustrating an example of a system that supports adaptive electrical vehicle (EV) scheduling according to one or more aspects of the disclosure. The system 100 may include a scheduling system 102. The system 100 may further include an order management system 150, a fleet management system 160, a map provider system 170, and an EV fleet 180.

The scheduling system 102 may include or correspond to one or more of a server, a desktop computing device, a laptop computing device, a personal computing device, a tablet computing device, a mobile device (e.g., a smartphone, a tablet, a personal digital assistant (PDA), one or more other computing devices, or a combination thereof, as non-limiting examples. The scheduling system 102 includes one or more processors 104, a memory 106, and one or more communication interfaces 110.

In some other implementations, one or more additional components (not shown) may be included in the scheduling system 102, such as one or more cloud servers, one or more edge devices, one or more IoT devices or the like. It is noted that functionalities described with reference to the scheduling system 102 are provided for purposes of illustration and that the exemplary functionalities described herein may be provided via other types of computing resource deployments. For example, in some implementations, computing resources and functionality described in connection with the scheduling system 102 may be provided in a distributed system using multiple servers or other computing devices, or in a cloud-based system using computing resources and functionality provided by a cloud-based environment that is accessible over a network. To illustrate, one or more operations described herein with reference to the scheduling system 102 may be performed by one or more servers or a cloud-based system that communicates with one or more control systems or user devices.

The one or more processors 104 may include one or more microcontrollers, application specific integrated circuits (ASICs), field programmable gate arrays (FPGAs), central processing units (CPUs) having one or more processing cores, or other circuitry and logic configured to facilitate the operations of the scheduling system 102 in accordance with aspects of the present disclosure. The memory 106 may include random access memory (RAM) devices, read only memory (ROM) devices, erasable programmable ROM (EPROM), electrically erasable programmable ROM (EEPROM), one or more hard disk drives (HDDs), one or more solid state drives (SSDs), flash memory devices, network accessible storage (NAS) devices, or other memory devices configured to store data in a persistent or non-persistent state. Software configured to facilitate operations and functionality of the scheduling system 102 may be stored in the memory 106 as instructions 108 that, when executed by the one or more processors 104, cause the one or more processors 104 to perform one or more operations described herein with respect to the scheduling system 102, as described in more detail below. Additionally, the memory 106 may be configured to store data and information, such as the instructions 108.

The one or more communication interfaces 110 may be configured to communicatively couple the scheduling system 102 to one or more networks via wired or wireless communication links established according to one or more communication protocols or standards (e.g., an Ethernet protocol, a transmission control protocol/internet protocol (TCP/IP), an Institute of Electrical and Electronics Engineers (IEEE) 802.11 protocol, an IEEE 802.16 protocol, a 3rd Generation (3G) communication standard, a 4th Generation (4G)/long term evolution (LTE) communication standard, a 5th Generation (5G) communication standard, Bluetooth, Zigbee, and the like). In some implementations, the scheduling system 102 includes one or more input/output (I/O) devices that include one or more display devices, a keyboard, a stylus, one or more touchscreens, a mouse, a trackpad, a microphone, a camera, one or more speakers, haptic feedback devices, or other types of devices that enable a user to receive information from or provide information to the scheduling system 102. In some implementations, the scheduling system 102 is coupled to a display device, such as a monitor, a display (e.g., a liquid crystal display (LCD) or the like), a touch screen, a projector, a virtual reality (VR) display, an augmented reality (AR) display, an extended reality (XR) display, or the like. In some other implementations, the display device is included in or integrated in the scheduling system 102.

In some implementations, the scheduling system 102 may include or may execute an adaptive EV scheduling engine 126. The adaptive EV scheduling engine 126 may use or may include artificial intelligence (AI) or machine learning (ML) functionality. For example, the adaptive EV scheduling engine 126 may operate based on or may include one or more ML models.

In some implementations, the adaptive EV scheduling engine 126 may include one or more of an order classification engine 130, a vehicle classification and order provisioning engine 132, or a vehicle order mapping engine 134. The vehicle order mapping engine 134 may include one or more of a reverse logistics engine 136 or an AI-based factor recalibration engine 138.

The EV fleet 180 may include multiple EVs, such as a representative EV 182. To illustrate, the EV fleet 180 may include one or more electric trucks, such as an electric semi-truck or an electric passenger truck. Alternatively or in addition, the EV fleet 180 may include one or more other types of electric vehicles, such as an electric car, an electric bus, an electric motorcycle, an electric bicycle, an electric forklift, an electric scooter, an electric personal transporter, one or more other types of electric vehicles, or a combination thereof, as illustrative examples. Alternatively or in addition, in some implementations, the EV fleet 180 may include one or more airborne EVs (e.g., a drone), one or more rail-based EVs (e.g., an electric train), one or more seaborne EVs (e.g., an electric boat), one or more spacecraft EVs, one or more other types of electric vehicle, or a combination thereof, as illustrative examples. Further, as referred to herein, EVs may include vehicles that include an electric propulsion system as well as hybrid electric vehicle (HEVs), such as a vehicle that includes both an internal combustion engine and an electric propulsion system.

Additionally, one or more aspects described herein may be applicable to non-EVs, such as internal combustion engine (ICE) powered vehicles. To illustrate, although some examples have been described with reference to charging an EV at a charging station, in some other examples, a non-EV may be fueled at a fuel station. In some examples, the EV fleet 180 may include one or more non-EVs. In another example, a fleet of non-EV vehicles may be scheduled (e.g., instead of the EV fleet 180) in accordance with one or more aspects described herein.

In some examples of an EV implementation, an EV of the EV fleet 180 may include one or more batteries. For example, the EV 182 may include a representative battery 184. The battery 184 may supply power to a drivetrain or other propulsion system of the EV 182. The battery 184 may have a rechargeable configuration. In some examples, the battery 184 may include or correspond to a lithium-ion battery (LIB). In other implementations, the battery 184 may be of another battery type. Alternatively or in addition, an EV of the EV fleet may include another type of system. For example, alternatively or in addition to the battery 184, the EV 182 may include a collector system that receives power from a power source that may be external or internal to the EV 182. In some examples, the collector system may include one or more solar panels that generate electricity based on solar energy and that provide the electricity to a propulsion system of the EV 182 or the battery 184.

The EV fleet 180 may include one or more driver-controlled EVs, one or more autonomous EVs, or a combination thereof. To illustrate, in some implementations, a driver may operate the EV 182 on one or more routes, such as from a vehicle storage facility to a pickup location (also referred to herein as a loading location), from the pickup location to a delivery location (also referred to herein as an unloading location), and from the delivery location to the vehicle storage facility. In some other implementations, the EV 182 may correspond to an autonomous vehicle that is self-operated without driver control. In some other implementations, the EV 182 may be partially autonomous, such as where the EV 182 is self-operated for one or more of the routes or portions thereof and is driver-operated for one or more other routes or portions thereof, where operation of the EV 182 is monitored by an on-board driver or supervisor, or where operation of the EV 182 is remotely monitored by a remote operator (e.g., via a video feed provided from the EV 182 to the remote operator).

During operation, the scheduling system 102 may receive order data 152 from the order management system 150. The order data 152 may indicate deliveries 154 (also referred to herein as orders). For example, the order management system 150 may receive customer requests to perform the deliveries 154, such as by prompting customers to input the customer requests via an interface (e.g., a web interface) that solicits order information from the customers. The order management system 150 may provide the customer requests to the scheduling system 102 as the order data 152 to enable the scheduling system 102 to assign EVs of the EV fleet 180 to perform the deliveries 154. In some examples, the order data 152 may indicate, for each of the deliveries 154, one or more of an order size (e.g., volume, weight, or both), a pickup location, a delivery location, an estimated time of arrival (ETA) (or requested time of arrival), a permissible leeway or flexibility (such as an acceptable range of delivery times, delivery locations, or delivery costs), an order type (such as perishable or non-perishable goods, liquid or solid goods, etc.), a service level agreement (SLA) parameter, or one or more other parameters, as illustrative examples.

The scheduling system 102 may receive vehicle data 162 from the fleet management system 160. The vehicle data 162 may indicate vehicle parameters 164 associated with the EV fleet 180, such as inventory attributes associated with the EV fleet 180. To illustrate, the vehicle parameters 164 may indicate, for one or more EVs of the EV fleet 180, one or more of a vehicle range, a vehicle type, a vehicle capacity (e.g., a vehicle volume or weight), a trailer size, a battery status, a maintenance schedule, a state of health (SOH) of a battery (e.g., a total running range or total running capacity of the battery), a state of charge (SOC) of a battery (e.g., a current running range or current running capacity of the battery), a driver availability, or one or more other parameters, as illustrative examples. In some examples, the fleet management system 160 may receive at least some of the vehicle data 162 from one or more of a service management system or a driver management system.

The scheduling system 102 may receive mapping data 172 from the map provider system 170. For example, the mapping data 172 may indicate environmental parameters 174, such as one or more of a current weather condition (e.g., temperature, humidity, etc.), a weather prediction or forecast, a charging station location and operation characteristic, a distance to a charging station, a travel time to a charging station, a traffic update, a road condition (e.g., an uphill grade or a downhill grade), a shortest driving path between two locations, or one or more other parameters, as illustrative examples.

The scheduling system 102 may receive first feedback data 186 based on operation of the EV fleet 180. The first feedback data 186 may be associated with one or more prior EV scheduling operations. For example, the first feedback data 186 may indicate one or more of a loading time (e.g., per customer and per station), an unloading time (e.g., per customer and per station), an average wait time at a loading station, an average wait time at an unloading station, a customer evaluation (e.g., a customer rating), a historical delay metric, fleet manager feedback, an average charging time, an SOC after charging, a driver behavior (such as a type of driver braking or a type of driver acceleration, etc.), one or more other parameters, or a combination thereof.

The scheduling system 102 may automatically generate (e.g., using the order classification engine 130, the vehicle classification and order provisioning engine 132, and the vehicle order mapping engine 134) vehicle-to-order scheduling data 140 associated with the order data 152, the vehicle data 162, and one or more charging parameters 120 associated with at least one EV of the EV fleet 180. In some examples, the scheduling system 102 determines the vehicle-to-order scheduling data 140 based further on one or more of the mapping data 172 or the first feedback data 186. The vehicle-to-order scheduling data may indicate a mapping of the deliveries 154 to at least some EVs of the EV fleet 180.

In some examples, the one or more charging parameters 120 may indicate one or more of an SOC associated with one or more batteries of the EV fleet 180 (e.g., the battery 184), an SOH associated with one or more batteries of the EV fleet 180 (e.g., the battery 184), a location of a charging station for at least one EV of the EV fleet 180, an average charging duration associated with the at least one EV, or an intelligent charging parameter (e.g., an amount of charging to be performed) associated with the at least one EV.

In some examples, the intelligent charging parameter may indicate or may be used to determine an amount of charging to be performed for a vehicle for a particular delivery of the deliveries 154. To illustrate, the adaptive EV scheduling engine 126 may determine, based on the mapping data 172, a charging station at which EV 182 is to be charged (e.g., prior to the EV 182 performing the particular delivery). The adaptive EV scheduling engine 126 may determine, based on the one or more charging parameters 120, an SOC associated with the EV 182. Based on the order data 152, the adaptive EV scheduling engine 126 may determine an estimated charge consumption associated with the particular delivery (e.g., based on a travel distance associated with the particular delivery). Based on a difference between the SOC and the estimated charge consumption, the adaptive EV scheduling engine 126 may generate an indication of an amount of charging to be performed for the EV 182 at the charging station. The vehicle-to-order scheduling data 140 may include the indication of the amount of charging. As a result, delivery time associated with the particular delivery may be reduced (e.g., by “intelligently” charging the EV 182 based on an actual amount of charge needed for the particular delivery instead of fully charging the EV 182, which may be unnecessary and which may delay the particular delivery).

In some examples, the vehicle data 162 may include at least one charging parameter of the one or more charging parameters 120. Alternatively or in addition, the scheduling system 102 may receive at least one charging parameter of the one or more charging parameters 120 from one or more other sources, such as via the first feedback data 186.

To further illustrate, in some examples, EVs of the EV fleet 180 may wirelessly transmit the one or more charging parameters 120 to the scheduling system 102 or to a device accessible to the scheduling system 102, such as to a cloud server. To illustrate, the EV 182 may automatically or periodically report to the scheduling system 102 one or more of an SOC of the battery 184, an SOH of the battery 184, or an average charging duration of the battery 184, such as based on detecting an event. In some examples, the event may include one or more of initiation of a charging operation at a charging station or initiation of a maintenance operation of the EV 182, as illustrative examples.

EVs of the EV fleet 180 may transmit such data using a variety of techniques, such as using a push technique or a pull technique. In an illustrative example of a push technique, the EV 182 may transmit such data to the scheduling system 102 (or other device) without receiving a request for such data. In an illustrative example of a pull technique, the EV 182 may receive a request for the data from the scheduling system 102 and may transmit the data to the scheduling system 102 based on the request.

In some examples, the vehicle data 162 may indicate a maintenance status 122 associated with at least one EV of the EV fleet 180, and the scheduling system 102 determines the vehicle-to-order scheduling data 140 based on the maintenance status 122. To illustrate, the maintenance status 122 may indicate whether vehicle maintenance is scheduled for the EV 182 within a particular time frame (e.g., within the next day, week, month, or other time frame). Based on the maintenance status 122 indicating that no vehicle maintenance is scheduled for the EV 182 within the particular time frame, the scheduling system 102 may assign, via the vehicle-to-order scheduling data 140, the EV 182 to a particular delivery of the deliveries 154 based on a first priority (e.g., a high priority). In some other examples, based on the maintenance status 122 indicating that vehicle maintenance is scheduled for the EV 182 within the particular time frame, the scheduling system 102 may associate the EV 182 with a second priority (e.g., a low priority) that is less than the first priority. To illustrate, in some such examples, the EV 182 may be assigned to a low-priority delivery of the deliveries 154 (e.g., a delivery having a relatively large amount of leeway or flexibility) or may not be assigned to any of the deliveries 154, such as where a quantity (also referred to herein as cardinality or number) of EVs of the EV fleet 180 exceeds a quantity of the deliveries 154 or an estimated quantity of EVs needed to service the deliveries 154.

Alternatively or in addition, in some examples, the vehicle data 162 may indicate a utilization metric 124 associated with an EV of the EV fleet 180, such as the EV 182. For example, the utilization metric 124 may correspond to a percentage of time that the EV 182 is in operation (e.g., traveling to a pickup location of a delivery, performing the delivery, or returning from the delivery) or another metric. Based on the utilization metric 124 failing to exceed a utilization threshold, the scheduling system 102 may assign, via the vehicle-to-order scheduling data 140, the EV 182 to a particular delivery of the deliveries 154 based on a first priority (e.g., a high priority). In some other examples, based on the utilization metric 124 exceeding the utilization threshold, the scheduling system 102 may associate the EV 182 with a second priority (e.g., a low priority) that is less than the first priority. To illustrate, in some such examples, the EV 182 may be assigned to a low-priority delivery of the deliveries 154 (e.g., a delivery having a relatively large amount of leeway or flexibility) or may not be assigned to any of the deliveries 154 (e.g., where a quantity of EVs of the EV fleet 180 exceeds a quantity of the deliveries 154 or the quantity of EVs exceeds a quantity of EVs needed to service the deliveries 154).

In some examples, after assigning a particular EV (e.g., the EV 182) of the EV fleet 180 to a particular delivery of deliveries 154, the scheduling system 102 may perform a reverse logistics operation (e.g., using the reverse logistics engine 136) to determine whether the EV 182 is to be assigned at least one other delivery of the deliveries 154. To illustrate, performing the reverse logistics operation may include determining that the EV 182 has capacity (e.g., one or more of weight capacity, volume capacity, charge capacity of the battery 184, or distance capacity) to perform the at least one other delivery. Based on determining that the EV 182 has the capacity to perform the at least one other delivery, the scheduling system 102 may modify the vehicle-to-order scheduling data 140 to indicate that the EV 182 is further assigned the at least one other delivery. In some other examples, performing the reverse logistics operation may include determining that the EV 182 does not have capacity to perform the at least one other delivery. Based on determining that the EV 182 does not have the capacity to perform the at least one other delivery, the scheduling system 102 may complete (e.g., finalize) an assignment for the EV 182. To further illustrate, the scheduling system 102 may perform the reverse logistics operation based on one or more of a delivery distance associated with the at least one other delivery, a volume associated with the at least one other delivery, or a weight associated with the at least one other delivery, such as by comparing the delivery distance to a remaining charge capacity or remaining distance capacity of the EV 182, by comparing the volume to a remaining volume capacity of the EV 182, by comparing the weight to a remaining weight capacity of the EV 182, based on a current location of the EV 182, or a combination thereof.

The scheduling system 102 may transmit (e.g., via the one or more communication interfaces 110) the vehicle-to-order scheduling data 140 to initiate dispatch of at least some EVs of the EV fleet 180 for performance of the deliveries 154. To illustrate, the scheduling system 102 may transmit the vehicle-to-order scheduling data 140 to a vehicle storage facility to dispatch the at least some EVs of the EV fleet 180 to perform the deliveries 154, such as by dispatching the EVs to respective pickup locations (e.g., one or more warehouses or other locations) associated with the deliveries 154. Alternatively or in addition, in some cases, an EV may receive the vehicle-to-order scheduling data 140 while performing or returning from another delivery, while being charged, while being serviced according to a maintenance schedule, or based on another condition or event. In such instances, assignment of the EV to a particular delivery may involve a location of the EV or a route associated with the deliveries assigned to the EV, such as when a delivery is scheduled for pickup at a location proximate to a planned route of the EV (e.g., a route planned for deliveries currently assigned to the EV) or current location of the EV. In this context, being proximate to the EV or the route of the EV may signify that the location associated with the delivery (e.g., a pickup location, a drop-off location, or both) are within a threshold distance of the EV's route or current location, where the threshold distance may be specified as a unit of distance (e.g., feet, yards, meters, miles, kilometers, etc.), a function of a charge level of a battery of the EV (e.g., whether the EV has sufficient charge to accommodate the delivery in addition to any deliveries already assigned to the EV), or some other metric.

In some implementations, one or more EVs of the EV fleet 180 may be automatically dispatched based on the vehicle-to-order scheduling data 140. In some such examples, the vehicle-to-order scheduling data 140 may be transmitted directly to the one or more EVs (e.g., to cause the one or more EVs to “wake up,” such as by powering up propulsion systems of the one or more EVs). For example, the one or more EVs may include autonomous or at least partially autonomous vehicles that may autonomously travel to a particular location. In one example, the particular location may include or may correspond to a pickup location where an autonomous EV may be loaded with goods to be delivered to a drop-off location. In another example, the particular location may correspond to a driver rendezvous location. To illustrate, an autonomous EV may autonomously travel to a home of a driver, and the driver may operate or the autonomous EV from the home of the driver to a pickup location. In some other examples, the particular location may correspond to a particular region of a vehicle storage facility (e.g., where the autonomous EV may autonomously travel from a parking stall to a driver loading area, which may reduce or avoid time spent by the driver searching for the autonomous EV within the vehicle storage facility).

In some examples, the vehicle-to-order scheduling data 140 may identify respective drivers associated with one or more EVs of the EV fleet 180. For example, each delivery of the deliveries 154 may be matched with a respective EV and with a respective driver. In some examples, multiple deliveries of the deliveries 154 may be matched with a respective EV and with a respective driver. To illustrate, in some such examples, an EV may be loaded at a pickup location with a first set of goods to be delivered to a drop-off location. After delivering the first set of goods, the EV may return to the pickup location (or may travel to another pickup location) to receive a second set of goods to be delivered to the drop-off location or to another drop-off location. In some such examples, a volume or weight of a sum of the first set of goods and the second set of goods may exceed a volume or weight capacity of the EV. In some other examples, the EV may concurrently receive both the first set of goods and the second set of goods at a pickup location (e.g., where the volume or weight of the sum of the first set of goods and the second set of goods does not exceed the volume or weight capacity of the EV).

Alternatively or in addition, in some implementations, one or more of the deliveries 154 may be scheduled for one or more autonomous EVs of the EV fleet 180. In such examples, the vehicle-to-order scheduling data 140 may not indicate a driver for the one or more deliveries scheduled for autonomous EVs. In such an implementation, the vehicle-to-order scheduling data 140 may provide information to a user at a warehouse or other location where a scheduled delivery is to be loaded (to facilitate loading of deliveries upon arrival of the autonomous EV(s)).

After dispatch, EVs of the EV fleet 180 may perform the deliveries 154 and may report parameters back to the system 100 (e.g., to the scheduling system 102 or to one or more other devices, sub-systems, or other components of the system 100) based on the performance of the deliveries 154. For example, the EVs may provide second feedback data 188 to the scheduling system 102. In some examples, the EVs may transmit or may upload the second feedback data 188 upon completing deliveries (e.g., at a drop-off location), upon returning to a vehicle storage facility, during charging, during maintenance, during another event, or a combination thereof. In some examples, the second feedback data 188 may indicate one or more of a loading time (e.g., per customer and per station), an unloading time (e.g., per customer and per station), an average wait time at a loading station, an average wait time at an unloading station, a customer evaluation (e.g., a customer rating), a historical delay metric, fleet manager feedback, an average charging time, an SOC after charging, a driver behavior (such as a type of driver braking or a type of driver acceleration, etc.), one or more other parameters, or a combination thereof.

In some examples, the scheduling system 102 may determine one or more parameters for one or more operations based on feedback data described herein (such as one or more of the first feedback data 186 or the second feedback data 188). To illustrate, the scheduling system 102 may determine, based on the second feedback data 188, one or more of a recentness metric, a clustering metric, or a delay frequency metric associated with performance of the deliveries 154. In some examples, determining one or more of the recentness metric, the clustering metric, or the delay frequency metric includes inputting a training set to the AI-based factor recalibration engine 138 to train the AI-based factor recalibration engine 138 to determine one or more of the recentness metric, the clustering metric, or the delay frequency metric. Further, in some examples, the scheduling system 102 (or another device, sub-system, or component of the system 100) may perform one or more operations based on such metrics, such as by performing one or more of reporting, tracking, or trend analysis based on one or more of the recentness metric, the clustering metric, or the delay frequency metric.

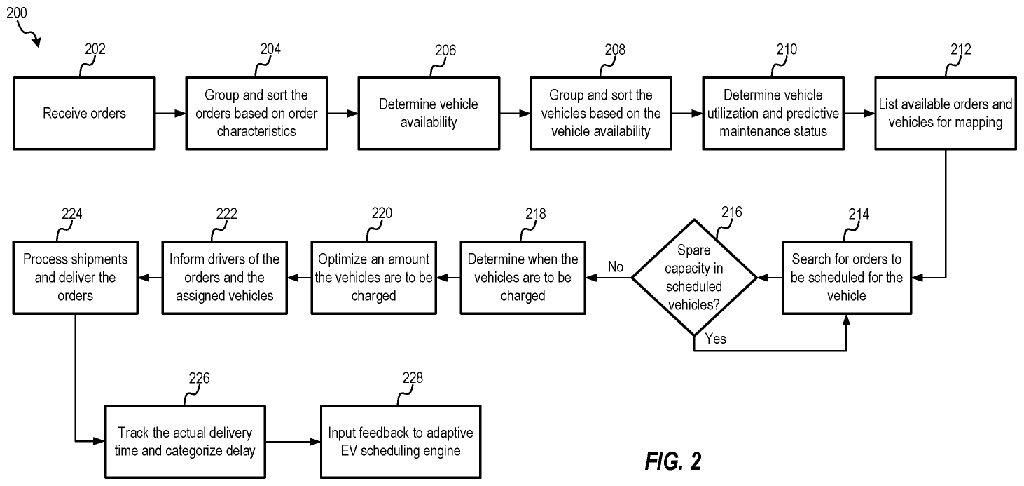

FIG. 2 is a flow diagram illustrating an example of a method 200 that supports EV scheduling according to one or more aspects of the disclosure. In some examples, the method 200 may be performed by the scheduling system 102 of FIG. 1, such as by the adaptive EV scheduling engine 126. In some examples, the scheduling system 102 of FIG. 1 may autonomously perform the method 200 (e.g., with “zero touch” operation).

The method 200 may include receiving orders, at 202. For example, the scheduling system 102 may receive the order data 152 from the order management system 150.

The method 200 may further include grouping and sorting the orders based on order characteristics, at 204. For example, the order classification engine 130 may group and sort the deliveries 154 based on characteristics of the deliveries 154.

The method 200 may further include determining vehicle availability, at 206. For example, the vehicle classification and order provisioning engine 132 may identify vehicles of the EV fleet 180 that are available, such as based on the vehicle data 162.

The method 200 may further include grouping and sorting the vehicles based on the vehicle availability, at 208. For example, the vehicle classification and order provisioning engine 132 may group and sort the vehicles of the EV fleet 180 based on availability of each of the vehicles.

The method 200 may further include determining vehicle utilization and predictive maintenance status, at 210. For example, the vehicle classification and order provisioning engine 132 may identify, for each vehicle of the EV fleet 180, vehicle utilization and predictive maintenance status, which may be indicated by the vehicle data 162.

The method 200 may further include listing available orders and vehicles for mapping, at 212. For example, the vehicle order mapping engine 134 may list the deliveries 154 of the order data 152 and may list available vehicles of the EV fleet 180.

The method 200 may further include searching for orders to be scheduled for the vehicle, at 214. For example, the vehicle order mapping engine 134 may search for one or more of the deliveries 154 to be performed by each vehicle of the EV fleet 180.

The method 200 may further include determining whether spare capacity exists in one or more scheduled vehicles, at 216. If one or more scheduled vehicles have spare capacity, the method 200 may further include searching for one or more orders to be scheduled for the one or more vehicles, at 214. If no scheduled vehicles have spare capacity, the method 200 may include determining when the vehicles are to be charged, at 218. For example, the vehicle order mapping engine 134 may determine when the vehicles are to be charged based on the one or more charging parameters 120.

The method 200 may further include determining or optimizing an amount the vehicles are to be charged, at 220. For example, the vehicle order mapping engine 134 may select, for each EV of the EV fleet 180, an intelligent amount of charging to be applied to the EV.

The method 200 may further include informing drivers of the orders and the assigned vehicles, at 222. For example, the vehicle-to-order scheduling data 140 may be provided to the drivers to indicate to each driver which vehicle of the EV fleet 180 and which delivery of the deliveries 154 are assigned to the driver.

The method 200 may further include processing shipments and delivering the orders, at 224. For example, EVs of the EV fleet 180 may perform the deliveries 154, which may include one or more shipments of goods (e.g., from a pickup location to a drop-off location).

The method 200 further includes tracking the actual delivery time and categorizing delay, at 226. For example, the second feedback data 188 may be provided to the scheduling system 102 to indicate parameters such as the actual delivery time and category of delay.

The method 200 may further include inputting the feedback to the adaptive EV scheduling engine, at 228. For example, the AI-based factor recalibration engine 138 may receive the second feedback data 188 and may perform one or more operations based on the second feedback data 188.

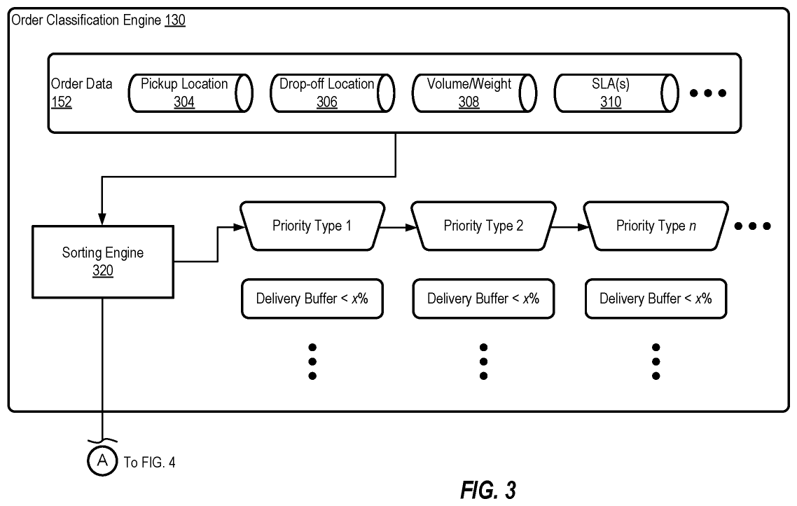

FIG. 3 is a diagram illustrating an example of the order classification engine 130 according to one or more aspects of the disclosure. In FIG. 3, the order classification engine 130 may receive the order data 152. In some examples, the order data 152 may indicate one or more of a pick-up location 304, a drop-off location 306, a volume or weight metric 308, or one or more SLAs 310.

In some examples, the order data 152 may be input to a sorting engine 320. The sorting engine 320 may sort the order data 152. For example the sorting engine 320 may sort the order data 152 based on priority, such as by assigning each of the deliveries 154 to one of a first priority (e.g., priority type 1), to a second priority (e.g., to priority type 2), or to an nth priority (e.g., priority type n), where n indicates a positive integer number of priority types. Further, each priority type may be associated with a respective delivery buffer. Each respective delivery buffer may be associated with (or “filled” with) deliveries of the deliveries 154 up to a delivery capacity of the delivery buffer, which is illustrated in FIG. 3 as x. After performing sorting and classification of the order data 152, the order classification engine 130 may output sorted order data to the vehicle classification and order provisioning engine 132.

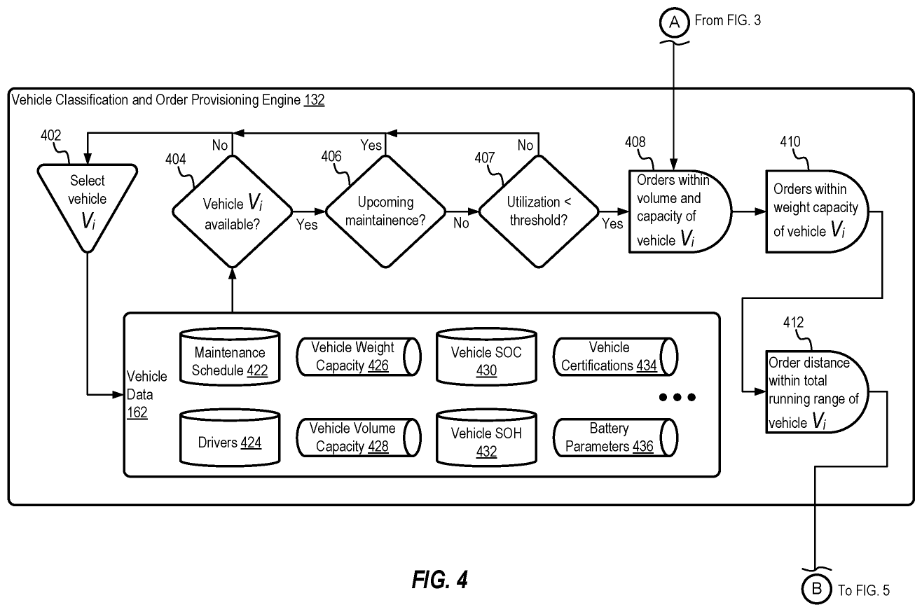

FIG. 4 is a diagram illustrating an example of the vehicle classification and order provisioning engine 132 according to one or more aspects of the disclosure. The vehicle classification and order provisioning engine 132 may select a vehicle Vᵢ from among the EV fleet 180, at 402 (where i indicates the ith vehicle V of the EV fleet 180). For example, a vehicle Vᵢ may be selected based on the vehicle data 162, such as based on the vehicle data 162 indicating that the EV fleet 180 includes the vehicle Vᵢ.

The vehicle classification and order provisioning engine 132 may determine whether the vehicle Vᵢ is available, at 404. For example, determining whether the vehicle Vᵢ is available may include determining whether the vehicle Vᵢ is parked at (or located at) a vehicle storage facility. If a vehicle Vᵢ is not available, operation of the vehicle classification and order provisioning engine 132 may return to 402.

If the vehicle Vᵢ is available, the vehicle classification and order provisioning engine 132 may determine whether the vehicle Vᵢ is associated with upcoming maintenance (e.g., based on the maintenance status 122), at 406. If the vehicle Vᵢ is associated with upcoming maintenance, operation may return to 402. If the vehicle Vᵢ is not associated with upcoming maintenance, the vehicle classification and order provisioning engine 132 may determine whether a utilization (e.g., the utilization metric 124) associated with the vehicle Vᵢ is less than a threshold, at 407.

In some examples, the vehicle classification and order provisioning engine 132 may determine the threshold based on one or more criteria. For example, the vehicle classification and order provisioning engine 132 may determine the threshold based on a load balancing scheme, such as where the threshold is selected to enable a distribution of work among EVs of the EV fleet 180. In such examples, the threshold may be selected so that a utilization of one EV does not exceed a utilization of another EV by more than a particular amount. Alternatively or in addition, in some examples, the threshold may be selected based on a vehicle reliability metric. In such examples, the threshold may be selected to avoid a relatively large amount of operation time (e.g., road time) that may introduce mechanical stress or battery stress to a vehicle. Further, the threshold may be set for multiple vehicles of the EV fleet 180 or may be specific to a particular EV of the EV fleet 180.

If the utilization greater than or equal to the threshold, operation may return to 402. If the utilization is less than the threshold, the vehicle classification and order provisioning engine 132 may determine that one or more orders within a volume and capacity of the vehicle Vᵢ (e.g., based on sorted order data provided by the order classification engine 130), at 408.

At 410, the vehicle classification and order provisioning engine 132 may determine that the orders are within a weight capacity of the vehicle Vᵢ. Further, at 412, the vehicle classification and order provisioning engine 132 may determine that an order distance is within a total running range of the vehicle Vᵢ (e.g., based on the vehicle data 162). In the example of FIG. 4, the vehicle data 162 may include, for each vehicle of the EV fleet 180, one or more of a maintenance schedule 422, one or more drivers 424, a vehicle weight capacity 426, a vehicle volume capacity 428, a vehicle SOC 430, a vehicle SOH 432, one or more vehicle certifications 434, or one or more battery parameters 436. Alternatively or in addition, the vehicle data 162 may include other data. In some examples, the one or more charging parameters 120 of FIG. 1 may include at least some of the vehicle data 162, such as one or more of the vehicle SOC 430, the vehicle SOH 432, the one or more vehicle certifications 434, or the one or more battery parameters 436.

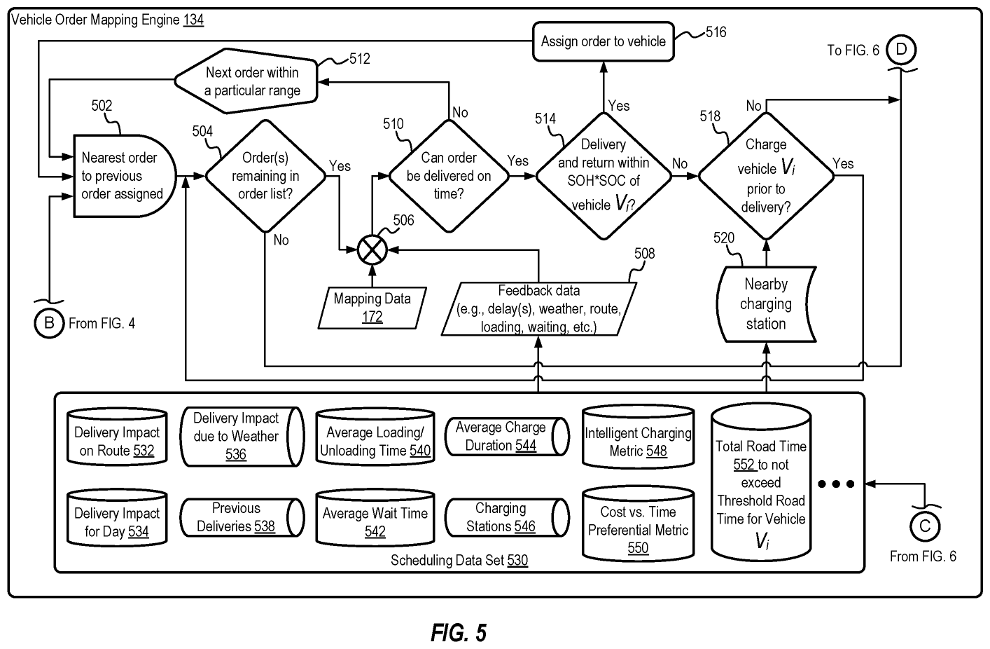

FIG. 5 is a diagram illustrating an example of the vehicle order mapping engine 134 according to one or more aspects of the disclosure. The vehicle order mapping engine 134 may identify a nearest order to a previous order assigned, at 502. The nearest order may also be referred to as a closest order to the previous order assigned. To illustrate, the order classification engine 130 may assign indices to orders to indicate prioritization of the orders, such as indices of 1, 2, 3, 4, . . . n (e.g., where n is a positive integer indicating a quantity of the deliveries 154). In some examples, if the previous order assigned is order 1, then the nearest order may be order 2, and if the previous assigned order is order 3, then the nearest order may be order 4, and so on.

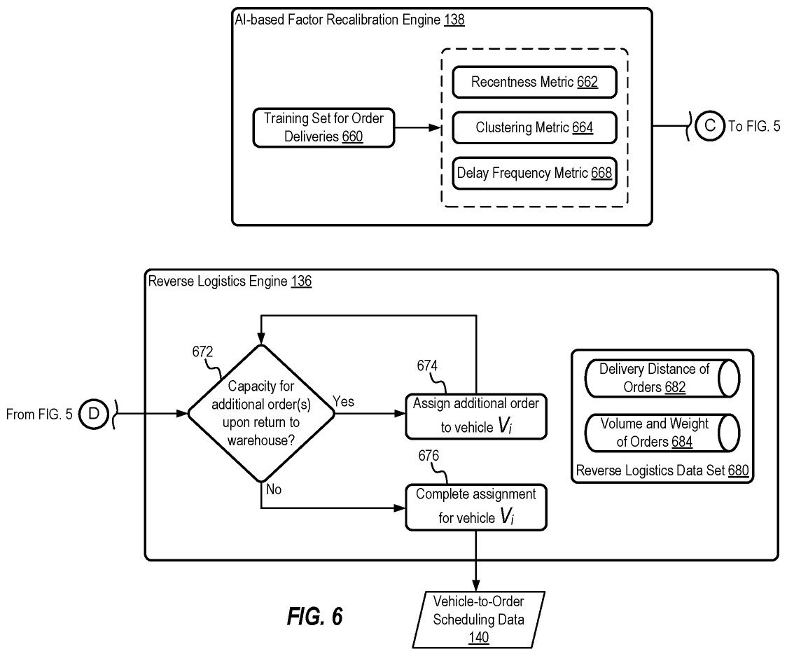

At 504, the vehicle order mapping engine 134 may determine whether one or more orders remain in an order list, such as by determining whether all deliveries of the deliveries 154 have been scheduled. If no orders remain in the order list (e.g., where all n orders have been assigned), operation may continue via reverse logistics engine 136, as described further with reference to FIG. 6. Alternatively, if one or more orders remain in the order list, the vehicle order mapping engine 134 may receive data, at 506, such as the mapping data 172 and feedback data 508. In some examples, the feedback data 508 may include data from one or more previous deliveries, such as data indicating one or more delays, weather, routes, loading, or waiting, etc. In some examples, the feedback data 508 may include one or more of the first feedback data 186 or the second feedback data 188.

At 510, the vehicle order mapping engine 134 may determine whether the order can be delivered on time. If the order cannot be delivered on time, the vehicle order mapping engine 134 may determine a next order within a particular range of orders (e.g., by considering the next order, the next two orders, the next three orders, or another number of numbers), at 512. If the order can be delivered on time, the vehicle order mapping engine 134 may determine, at 514, whether the delivery and return are within a SOH and SOC of the vehicle Vᵢ (e.g., based on a product of the SOH and SOH, or SOH*SOC). If the delivery and return are within the SOH and SOC of the vehicle Vᵢ, then the vehicle order mapping engine 134 may assign the order to the vehicle, at 516, and may select another vehicle Vᵢ, at 502. Otherwise, the vehicle order mapping engine 134 may determine, at 518, whether to charge the vehicle Vᵢ prior to the delivery, such as at a nearby charging station 520. If the vehicle Vᵢ is to be charged prior to delivery, operation may continue, at 504. Otherwise, operation may continue via the reverse logistics engine 136, as described with reference to FIG. 6.

As shown in FIG. 5, the vehicle order mapping engine 134 may perform one or more operations based on a scheduling data set 530. In some examples, the scheduling data set 530 may indicate one or more of a delivery impact on a route 532, a delivery impact for a day 534, a delivery impact due to weather 536, one or more previous deliveries 538, an average loading or unloading time 540, or an average wait time 542. Alternatively or in addition, the scheduling data set 530 may indicate one or more of an average charge duration 544, one or more charging stations 546, an intelligent charging metric 548, a cost versus time preferential metric 550, or a total road time 552, which may not be allowed to exceed a threshold road time for each respective vehicle Vᵢ. In some examples, the one or more charging parameters 120 of FIG. 1 may include at least some of the scheduling data set 530, such as one or more of the average charge duration 544, the one or more charging stations 546, or the intelligent charging metric 548. Further, in some examples, the vehicle order mapping engine 134 includes or communicates with the AI-based factor recalibration engine 138, as described further with reference to FIG. 6.

FIG. 6 is a diagram illustrating examples of the AI-based factor recalibration engine 138 and the reverse logistics engine 136 according to one or more aspects of the disclosure. As shown in FIG. 6, the AI-based factor recalibration engine 138 may perform operations based on a training set for order deliveries 660. For example, the AI-based factor recalibration engine 138 may determine one or more of a recentness metric 662, a clustering metric 664, or a delay frequency metric 668. In some examples, the training set for order deliveries 660 may include feedback data, such as any of the feedback data 186, 188. Alternatively or in addition, the training set for order deliveries 660 may include other data.

FIG. 6 also illustrates an example of the reverse logistics engine 136. For example, the reverse logistics engine 136 may determine, for each vehicle Vᵢ, whether the vehicle Vᵢ has capacity for one or more additional orders upon a return to a warehouse, at 672. If so, the reverse logistics engine 136 may assign an additional order to the vehicle Vᵢ, at 674, and operation may return to 672. Otherwise, the reverse logistics engine 136 may finalize or complete an assignment for the vehicle Vᵢ, at 676, which may be added to or indicated by the vehicle-to-order scheduling data 140.

In addition, the example of FIG. 6 illustrates that the reverse logistics engine 136 may perform one or more operations based on one or more parameters. The one or more parameters may include or correspond to a reverse logistics data set 680. The reverse logistics data set 680 may indicate a delivery distance 682 of each order and a volume and weight 684 of each order. The reverse logistics engine 136 may determine, at 672, whether the vehicle Vᵢ has capacity for one or more additional orders based on the reverse logistics data set 680.

To further illustrate some aspects of the disclosure, in some examples, the scheduling system 102 may generate the vehicle-to-order scheduling data 140 based on one or more of the following examples. In some examples, the deliveries 154 may be indicated as O₁, O₂, O₃, . . . Oₙ, where n is a positive integer indicating a quantity of the deliveries 154. A volume of each of the deliveries 154 may be indicated as Oᵥ₁, Oᵥ₂, Oᵥ₃, . . . Oᵥₙ, and a weight of each of the deliveries 154 may be indicated as O_{w1}, O_{w2}, O_{w3}, . . . O_{wn}. A delivery time (e.g., ETA) of each of the deliveries 154 may be indicated as Oₜ₁, Oₜ₂, Oₜ₃, . . . Oₜₙ, and a distance associated with each of the deliveries 154 (e.g., a distance from a pickup location to a drop-off location) may be indicated as O_{d1}, O_{d2}, O_{d3}, . . . O_{dn}.

The EV fleet 180 may be indicated as V₁, V₂, V₃, Vₘ, where m indicates a quantity of vehicles of the EV fleet 180. A compliance factor for the EV fleet 180 may be indicated as V_{c1}, V_{c2}, V_{c3}, V_{cm}, where V_{ci}={0,1}, where V_{ci}=0 if the ith vehicle is non-compliant, and where V_{ci}=1 if the ith vehicle is compliant. The compliance factor may indicate whether a vehicle is eligible for service based on compliance of the vehicle with a regulation, rule, constraint, or other metric.

An availability of the vehicle Vᵢ may be indicated as Vₘₜᵢ. For example, the availability may be determined based on whether the vehicle Vᵢ scheduled for maintenance in a particular time interval or whether a utilization metric associated with the vehicle Vᵢ exceeds a utilization threshold. Accordingly, the availability of vehicles of the EV fleet 180 may be indicated as Vₘₜ₁, Vₘₜ₂, Vₘₜ₃, Vₘₜₘ, where Vₘₜᵢ={0,1}, where Vₘₜᵢ=0 if the ith vehicle is unavailable, and where Vₘₜᵢ=1 if the ith vehicle is available.

A volume capacity associated with vehicles of EV fleet 180 may be indicated as Vᵥ₁, Vᵥ₂, Vᵥ₃, Vᵥₘ, and a weight capacity associated with vehicles of EV fleet 180 may be indicated as V_{w1}, V_{w2}, V_{w3}, V_{wm}. A total running range or other total SOH metric associated with vehicles of EV fleet 180 may be indicated as Vₛₕ₁, Vₛₕ₂, Vₛₕ₃, Vₛₕₘ, and a current running range or other SOC metric associated with vehicles of EV fleet 180 may be indicated as V_{sc1}, V_{sc2}, V_{sc3}, V_{scm}, where 0<V_{sci}<1. A running range for fully charged vehicles may be indicated as V_{scf1}, V_{scf2}, V_{scf3}, V_{scfin}.

An average leeway (or flexibility) associated with an order Oⱼ may be indicated as αⱼ. In some examples, one or more orders may be more “flexible” than one or more other orders in terms of one or more criteria, such as one or more of delivery time, delivery location, or delivery cost.

One or more previous delivery instances of an order Oⱼ being delivered along a route Rₖ on a day Dₗ (e.g., a particular day of week, month, and year) may be indicated as Aⱼₖₗ. The scheduling system 102 may generate the vehicle-to-order scheduling data 140 based on a delivery location of the order Oⱼ plus or minus a particular range for use in one or more operations, such as generating one or more downstream predictions or order assignments.

A first cumulative delay factor by which an order Oⱼ may be delayed along route Rₖ on day Dₗ may be indicated as [symbol] ⱼₖₗ. For example, [symbol] _{11M} may indicate the cumulative delay for order O₁ along route R₁ for a particular day D_{M} (e.g., Monday) for a quantity of instances the order O₁ has been previously delivered by any vehicle of the EV fleet 180. The route variable Rₖ may be determined based on the starting location and ending location of the order delivery.

A second cumulative delay factor by which an order Oⱼ may be delayed along route Rₖ may be indicated as βⱼₖ. In some examples, βⱼₖ=Σₗ [symbol] ⱼₖₗ. For example, β₁₁ may indicate the cumulative delay for an order O₁ along a route R₁ across a quantity of instances that the order O₁ has been delivered for any day and by any vehicle of the EV fleet 180.

A quantity of previous delays associated with an order Oⱼ due to one or more weather conditions along route Rₖ may be indicated as Zⱼₖ. A weather condition may include a condition such as precipitation (e.g., rainfall or snowfall), humidity, or visibility, as illustrative examples. In some examples, if no such delay occurs, then Zⱼₖ=0. In some examples, a weather severity value may be used. For example, Zⱼₖ may be weighted based on Zⱼₖ*sv, where sv may indicate a severity of weather on the day of scheduling (or delivery), and where 0<sv<1.

An average permissible amount of leeway (or flexibility) associated with an order Oⱼ along route Rₖ on day D₁ may be indicated as αⱼₖₗ. An average permissible amount of leeway (or flexibility) associated with an order Oⱼ along route Rₖ on any day may be indicated as μⱼₖₗ. In some examples, μⱼₖₗ may have the same value as αⱼₖₗ.

An average unloading time at an unloading location associated with an order Oⱼ and a vehicle Vᵢ may be indicated as Kᵢⱼ. In some examples, if an order is not delivered (e.g., due to an order cancelation, delivery delay, or other circumstance), then Kᵢⱼ=0. In some examples, Kᵢⱼ may be affected by one or more of an order weight or an order volume.

An average waiting time at an unloading location associated with an order Oⱼ and a vehicle Vᵢ may be indicated as Nu. In some examples, if an order is not delivered (e.g., due to an order cancelation, weather delay, or other circumstance), then Nᵢⱼ=0.

An average cumulative delay for each previous delivery of an order Oⱼ on route Rₖ may be indicated as bⱼₖᵥ, where v may indicate a quantity of instances of the order Oⱼ was previously delayed or delivered early. In some examples, the scheduling system 102 may omit one or more data samples as outliers or exceptions from bⱼₖᵥ (e.g., based on the AI-based factor recalibration engine 138 indicating that the one or more data samples are outliers or exceptions). In some examples, the scheduling system 102 may determine bⱼₖᵥ based on a combination or summation of one or more other delay values described herein, such as based on one or more of [symbol] ⱼₖₗ, βⱼₖ, Zⱼₖ, Kⱼₖ, or Nⱼₖ.

A previous average time to deliver order Oⱼ by vehicle Vᵢ along route Rₖ may be indicated as pᵢⱼₖ. In some examples, if an order is not delivered (e.g., due to an order cancelation, weather delay, or other circumstance), then pᵢⱼₖ=0.

A time taken on an initial basis to deliver order Oⱼ by vehicle Vᵢ along route Rₖ may be indicated as qᵢⱼₖ. In some examples, the scheduling system 102 may set qᵢⱼₖ to a default value or may receive qᵢⱼₖ from a third party. In some examples, if pᵢⱼₖ=0, then pᵢⱼₖ=qᵢⱼₖ else pᵢⱼₖ=aᵢⱼₖ+bⱼₖᵥ.

A distance to a closest charging station for vehicle Vᵢ at a given point in time may be indicated as W_{g}, where g may correspond to the total number of charging stations. In some examples, the scheduling system 102 (or another device, such as the map provider system 170) may determine W_{g} by finding a respective distance to each charging station from a particular location at a given point in time.

The time to reach the nearest charging station for vehicle Vᵢ may be indicated as T_{ig}, and the distance between the nearest charging station g and a location associated with order Oⱼ (e.g., a pickup location of order Oⱼ) may be indicated as D_{jg}. A time for vehicle Vᵢ to travel from the charging station g to the next order Oⱼ (e.g., a pickup location of the next order Oⱼ) may be indicated as u_{igj}. In some examples, the scheduling system 102 may receive an indication of u_{igj} from the map provider system 170 or from another third party.

A function G may indicate, for each vehicle Vᵢ, a set of orders that have volume ≤S*Vᵥᵢ*V_{ci}*Vₘₜᵢ, where s may indicate a factor of single order volume that is allowed in vehicle Vᵢ, and where 0<s≤1. To illustrate, in an example, G(Vᵢ)={O₁, O₄, O₈, O₁₀, . . . }.

A function H may indicate, for each vehicle Vᵢ, a set of orders that have weight ≤r*V_{wi}*V_{ci}*Vₘₜᵢ, where r may indicate a factor of single order weight that is allowed in vehicle Vᵢ, and where 0<r≤1. To illustrate, in an example, H(Vᵢ)={O₁, O₄, O₈, O₁₀, . . . }.

A function I may indicate, for each vehicle Vᵢ, a set of orders that have an order distance O_{dj}≤e*Vₛₕᵢ*V_{sci}. In some examples, e may correspond to 0.5 or another value.

A function J may indicate a set of orders such that J=(G∩H∩I). Oₓ may indicate any order from the set J. A distance from a pickup location of order Oₓ to a drop-off location of order Oₓ may be indicated as O_{dx}, and an estimated delivery time (e.g., an ETA) associated with order Oₓ may be indicated as Oₜₓ.

A set of orders currently assigned to vehicle Vᵢ may be indicated as Pᵢ. Initially (e.g., prior to operation of the adaptive EV scheduling engine 126, such as prior to one or more operations described with reference to FIGS. 3-6), Pᵢ may be null. A final set of Pᵢ may be the suggested assigned order for vehicle Vᵢ, which may be indicated by the vehicle-to-order scheduling data 140.

A function U may return the closest order by distance from the location of a previously assigned (or delivered) order from a set of orders without duplicates. If no order is previously assigned (or delivered), then U may return the closest order by distance from a pick-up location (e.g., a warehouse). For example, U((O₁, O₂, O₃, . . . Oₙ), L₁) may return the closest order amongst O₁, O₂, O₃, . . . Oₙ from the last assigned order (e.g., O₈).

A function R may return all orders within a threshold distance (z*y) from a particular order, where z is a value such that if R or U corresponds to a null set, then the value of z may be selected such that R or U is not null (e.g., by incrementing z by a value of one). For example, R(Oₖ, y) may indicate a list of orders with a distance y from order Oₖ.

In some examples, E=U((R(Oₓ, z*y)∩J), Lᵢ), where if Pᵢ is a null set, then E=U(J, Lᵢ), where Oₓ indicates the previous order assigned, and where Lᵢ indicates the current location of vehicle Vᵢ. E may indicate a dynamic set that changes based on the value of Oₓ, and any value excluded in the previous set of E may not be applicable to the subsequent set of E. A distance from a first order location 1 to a second order location 2 may be indicated by—(O₁-O₂) or by (O₂-O₁). For each vehicle Vᵢ assigned, a suggested set of orders (e.g., a set of orders specified by the vehicle-to-order scheduling data 140) may be represented according to Equation 1:

∀_{x∈E}[((γₓₖₗ>αₓₖₗ)∥(βⱼₖ>μⱼₖ))?[{((pᵢₓₖ+Kᵢₓ_{ₚᵣₑᵥ}+Nᵢₓ_{ₚᵣₑᵥ})<(Oₜₓ+αₓ))&&(((O_{dx}−O_{d(x}_{ₚᵣₑᵥ₎})+O_{dx})≤(Vₛₕᵢ*V_{sci}))}?((Oₓ∈Pᵢ),(J\x),(Vₛₕᵢ*V_{sci}=(Vₛₕᵢ*V_{sci}−(O_{dx}−O_{d(x}_{ₚᵣₑᵥ}₎))): [((W_{S}≤Vₛₕᵢ*V_{sci})&&(((O_{dx}−O_{d(x}_{ₚᵣₑᵥ}₎)+O_{dx})≤(Vₛₕᵢ*∀(V_{scdi})))&&((T_{ig}+u_{igx}+Kᵢₓ_{ₚᵣₑᵥ}+Nᵢₓ_{ₚᵣₑᵥ})≤(Oₜₓ+αₓ)))?((W_{g},Oₓ∈Pᵢ),(J\x),(Vₛₕᵢ*V_{sci}=(Vₛₕᵢ*V_{sdi}−(W_{g}+(O_{dx}−O_{d(x}_{ₚᵣₑᵥ}₎))))):(x=E)]]] (Equation 1).

In Equation 1, Bᵢ≤Θ₁, where Bᵢ may indicate a total time associated with vehicle Vᵢ (e.g., a total road time for a particular day) and may include time during travel, unloading, waiting, loading (e.g., at pickup locations indicated by Qₗⱼ), and travel back to a vehicle storage facility (or other location) from a final delivery. Θᵢ may indicate a maximum road time of vehicle Vᵢ for a single day. In some examples, xₚᵣₑᵥ may indicate a corresponding previous value of x in Pᵢ, where if Pᵢ is a null set, then xₚᵣₑᵥ=0. In some examples, the scheduling system 102 may perform one or more operations upon detecting a condition of (x=E), such as by searching for another value of E and by removing the current value of x from the set of E.

In Equation 1, V_{scdi} may be such that d indicates a progressive charging technique for a vehicle. For example, in a first charging instance, the vehicle may be charged only percent, and in a second charging instance, the vehicle may be charged the next 20 percent, and so on. In some examples, d may indicate a particular capacity to which a vehicle is progressively charged at a charging station. In some examples, the scheduling system 102 may adaptively learn to optimize a charging percentage for each vehicle while assigning orders. In some examples, if d=100 percent, then V_{scdi}=V_{scfi}.

In some examples, X may indicate a pickup location (e.g., a warehouse), Yᵢ may indicate a distance from a current location of vehicle Vᵢ (e.g., a distance from a vehicle storage facility) to the pickup location X, and Sₗ may indicate the set of orders, where l corresponds to the quantity of orders. The functions G and H may be applied to the set of orders Sₗ to determine a subset of orders within the volume and weight capacity of the vehicle.

In some examples, M=U((G(Vᵢ)∩H(Vᵢ)), Lᵢ), where Sᵢ indicates the distance of a closest pickup order S for a vehicle Vᵢ at any point in time, where S_{iw} indicates a distance from the closest pickup order S to a pickup location, and where Qₗⱼ indicates an average loading time for pickup order Sₗ and vehicle Vᵢ (e.g., where, for an order being delivered for the first time, Qₗⱼ=0). In some examples, such relationships may be expressed according to Equation 2:

For vehicleVᵢ−∀_{h∈M}[( [symbol] ᵢ≤(Vₛₕᵢ*V_{sci})_{final values})?[((Sᵢ+S_{iω})≤(Vₛₕᵢ*V_{sci})_{final values})?((h∈Pᵢ),(Sₗ\h),((Vₛₕᵢ*V_{sci})_{final values}=((Vₛₕᵢ*V_{sci})_{final values}−Sᵢ))):(X∈Pᵢ)]:(X∈Pᵢ)] (Equation 2).

One or more processes described herein may be performed iteratively. For example, a process associated with Equation 1 and Equation 2 may be performed during a first iteration for each vehicle associated with the EV fleet 180. After the first iteration, if one or more orders remain to be assigned, or if one or more vehicles of the EV fleet 180 are still available, the process may be performed again during a second iteration, etc. In some examples, order assignment may be performed after initial loading at a pickup location (e.g., warehouse). In some other examples, order assignment may be performed at another time (e.g., prior to initial loading).

In some examples, the scheduling system 102 may use feedback data in connection with one or more examples described herein. For example, the scheduling system 102 may determine values of [symbol] ⱼₖₗ, βⱼₖ, Nᵢⱼ, Kᵢⱼ and Zⱼₖ according with Equation 3:

$$( Equation 3 )$$

$${γ}_{jkl} \vert {β}_{jk} \vert {N}_{ij} \vert {K}_{ij} \vert {Z}_{jk} = [ \text{} {{\sum }_{j}}^{n} {\sum }_{k} {\sum }_{v} min ( ( ( ε * \tilde{a} * \frac{{b}_{jk vo}}{2} ) + σ * \hat{o} * \frac{{b}_{jk vo}}{2} ) ) , {b}_{jk vo} ) ] .$$

In Equation 3, a may indicate a recentness factor, where 0<â<1, where more recent instances are assigned a larger value of â. In some examples, ô may indicate a clustering factor, where 0<ô<1, and where clustered instances have greater ô than scattered instances. Further, bⱼₖᵥₒ may indicate a delay for each order Oⱼ along route Rₖ, where v may indicate a quantity of instances the order was previously delayed, and where o indicates a category (or type) of delay (e.g., where [symbol] ⱼₖₗ, βⱼₖ, Nᵢⱼ, Kᵢⱼ and Zⱼₖ each corresponds to a different category of delay). In addition, ε may indicate a weighing value assigned to recentness, and σ may indicate a weighting value assigned to clustering.

To further illustrate some aspects, in some examples, energy-efficient route planning may be performed with consideration of topography and battery lifetime. In contrast to some other routing systems, which may determine a shortest distance or fastest path to a destination, the scheduling system 102 may perform route planning specifically for electric vehicles by determining an energy-efficient route while also considering stress on a battery (e.g., using a Yen algorithm or using a modified Yen algorithm).

In some examples, routing optimization of EVs for charging with event-driven pricing strategy may be performed. In contrast to some other systems that focus on vehicle-road-network interactions, in some examples, the scheduling system 102 may also consider vehicle-to-vehicle interactions, such as simultaneous charging requests by EVs. To facilitate the interaction of multiple vehicles in route planning and charging, an event-driven pricing may be used.

In some implementations, charging costs may be reduced or minimized while also achieving relatively high energy-levels and optimal power balancing. In some aspects, a linear approximation model or a state dependent battery model may be used.

Further, EV charging scheduling may be performed based on a number of charging stations. For example, EV charging scheduling may be performed based on a time-of-use (TOU) electricity price. In an example, an uncontrolled charging model to rapidly fully charge EVs may be established. A charging scheduling model may consider an actual quantity of charging stations to reduce charging cost and to guarantee the charging demand of each EV. In some examples, a bilevel programming (BP) model may be used.

One or more aspects described herein may increase real time visibility into operations, may reduce operational cost through order optimization, may increase fleet productivity, and may reduce unplanned maintenance cost through load balancing. Further, one or more aspects described herein may improve customer experience, may reduce or avoid missed deliveries, may result in faster fulfillment, and may increase sustainability.

One or more features described herein may improve performance of a system, such as the system 100. For example, by planning dispatch operations based on the one or more charging parameters 120, energy expenditure associated with the deliveries 154 may be reduced, resulting in increased sustainability. To illustrate, assigning EVs of the EV fleet 180 to the deliveries 154 based on locations of charging stations (which may be indicated by the one or more charging parameters 120) may decrease an amount of time and distance traveled by an EV to a charging station, reducing road time, energy expenditure, and delivery latency in some instances. As a result, metrics such as cost and delivery time may be reduced while also reducing resource consumption (e.g., energy expenditure) and also increasing sustainability in the system 100.

As another example, use of feedback data (such as the first feedback data 186 and the second feedback data 188) may improve performance of the system 100. For example, the feedback data may indicate one or more of a loading time, an unloading time, an average wait time during loading, an average wait time during unloading, a customer rating, a historical delay, fleet manager feedback, an average charging time, an SOC after charging, or vehicle operational behavior (such as a type of braking or acceleration). In some examples, use of the feedback data may increase adaptiveness of the EV scheduling process and may enable dynamic operation of the adaptive EV scheduling engine.

As an additional example, in some implementations, the scheduling system 102 may perform adaptive EV scheduling autonomously (or with “zero touch” operation). For example, in some implementations, the scheduling system 102 may perform adaptive EV scheduling automatically and without input from a fleet manager. As a result, error and bias that may be associated with human intervention in the EV scheduling process may be reduced or eliminated in some implementations.

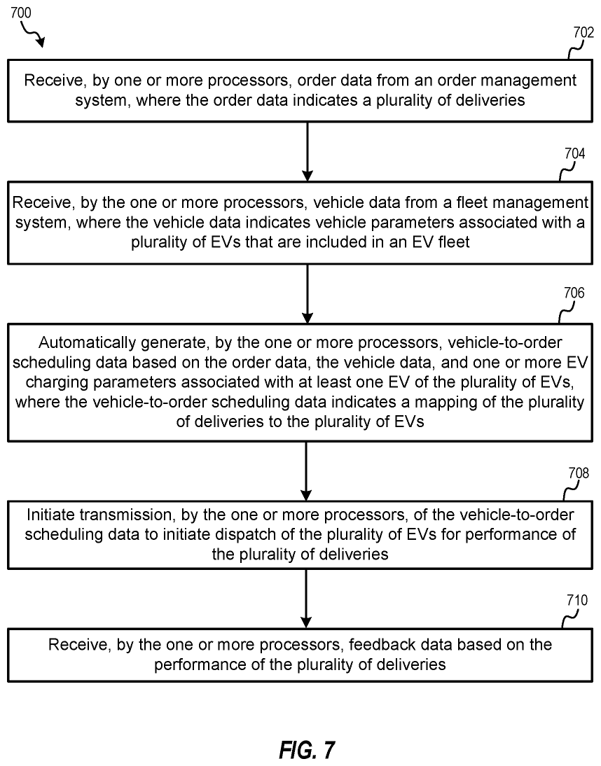

Referring to FIG. 7, a flow diagram of an example of a method for adaptive EV scheduling is shown as a method 700. In some implementations, the operations of the method 700 may be stored as instructions that, when executed by one or more processors (e.g., the one or more processors of a computing device or a server, such as the one or more processors 104), cause the one or more processors to perform the operations of the method 700. In some implementations, the method 700 may be performed by a computing device, such as the scheduling system 102 of FIG. 1.

The method 700 includes receiving, by one or more processors, order data from an order management system, at 702. The order data indicates a plurality of deliveries. For example, the one or more processors 104 may receive the order data 152 from the order management system 150 indicating the deliveries 154.

The method 700 further includes receiving, by the one or more processors, vehicle data from a fleet management system, at 704. The vehicle data indicates vehicle parameters associated with a plurality of EVs that are included in an EV fleet. For example, the one or more processors 104 may receive the vehicle data 162 from the fleet management system 160 indicating the vehicle parameters 164.

The method 700 further includes automatically generating, by the one or more processors, vehicle-to-order scheduling data based on the order data, the vehicle data, and one or more EV charging parameters associated with at least one EV of the plurality of EVs, at 706. The vehicle-to-order scheduling data indicates a mapping of the plurality of deliveries to the plurality of EVs. For example, the one or more processors 104 may automatically generate the vehicle-to-order scheduling data 140 based on the order data 152, the vehicle data 162, and the one or more charging parameters 120.

The method 700 further includes initiating transmission, by the one or more processors, of the vehicle-to-order scheduling data to initiate dispatch of the plurality of EVs for performance of the plurality of deliveries, at 708. For example, the one or more processors 104 may initiate transmission of the vehicle-to-order scheduling data 140 to initiate dispatch of at least some of (e.g., a subset of) the EV fleet 180.

The method 700 further includes receiving, by the one or more processors, feedback data based on the performance of the plurality of deliveries, at 710. For example, the one or more processors 104 may receive the second feedback data 188.

In some examples, the method 700 further includes performing one or more operations based on the feedback data. For example, the scheduling system 102 may perform one or more operations based on the second feedback data 188. The one or more operations may include inputting the feedback data to the AI-based factor recalibration engine 138. In some examples, the one or more operations include one or more of reporting, tracking, or trend analysis based on one or more of the recentness metric 662, the clustering metric 664, or the delay frequency metric 668.

As a further example, the operations performed by the method 700 based on the feedback data may include using received feedback data to perform dynamic scheduling and optimization of a fleet of EVs. For example, suppose that a fleet of EVs is assigned to deliveries and deployed as described above, and subsequent to deployment a new order or delivery is received. While an EV that has not been deployed or an EV that was deployed previously but has completed its scheduled deliveries and returned to the fleet yard could be used for the new delivery, the method 700 may use feedback data to perform dynamic scheduling in a manner that optimizes energy expenditure, time, or other factors.

As a non-limiting example, the feedback data may include information regarding a current location of the EV. Such feedback data may be provided periodically (e.g., at a particular frequency, such as every 5 minutes, 15 minutes, or another period of time) or continuously based on a GPS system of the EV. Additionally or alternatively, the location of the EV may be derived from other types of feedback data, as described in more detail below. Once the location of the EV is determined, the dynamic scheduling process may evaluate whether the EV satisfies a dynamic scheduling threshold. The dynamic scheduling threshold may correspond to a particular distance, such as whether the current location of the EV is within a threshold distance (e.g., 5 miles, 10 miles, etc.) of the new delivery. Additionally or alternatively, routing information associated with the deliveries assigned to the EV at the time of deployment may be used to evaluate whether the dynamic scheduling threshold is satisfied. For example, the current location of the EV may be used to determine the remaining set of deliveries assigned to the EV and the dynamic scheduling may determine whether the location of the new delivery is within a particular distance of a planned route for completing the remaining deliveries assigned to the EV. In the examples above, the new delivery may be assigned to the deployed EV when the dynamic scheduling determines that the new delivery is within the distance-based dynamic scheduling threshold (e.g., within a threshold distance of the EV's current location or within a threshold distance of a portion of a route planned for remaining deliveries of the EV).

In yet another non-limiting example, the feedback data may include data associated with a status of one or more deliveries assigned to the EV and the dynamic scheduling may use the status information to determine whether to assign the new delivery to the EV. To illustrate, the status information may indicate one or more completed deliveries and one or more incomplete deliveries. The dynamic scheduling may use the status information to determine a current location of the EV, such as by determining the last completed delivery location and a next scheduled delivery location, which may indicate an approximate location of the EV (e.g., the EV is between the location of the completed delivery and the location of the next scheduled delivery). Such approximate location information may then be used to determine whether the EV is within the threshold distance of the new delivery. As another example, the dynamic scheduling may determine a route the EV will use to complete the next delivery and/or one or more subsequent deliveries, if any, and then determine whether the EV will be within the threshold distance of the new delivery at some point during the estimated route(s). When the EV is determined to be within the threshold distance of the new delivery using the current or approximate location information techniques described above, the dynamic scheduling may assign the new delivery to the EV and provide updated scheduling data to the EV (or a device associated with the EV, such as a device of the driver).

As another example, feedback associated with a current or estimated charge level of the EV to perform dynamic scheduling. The charge level of the EV may indicate an amount of energy remaining in a power source of the EV, such as one or more batteries, fuel cells, and the like. Based on the feedback associated with the charge level, the dynamic scheduling may determine whether the charge level of the EV is sufficient to handle the new delivery. For example, the dynamic scheduling may use one of the distance-based techniques described above to evaluate a travel distance required for the EV if assigned the new delivery, which may be based on a distance from the EV's current or approximate location or a point along an estimated route of the EV, as described above. The travel distance may then be used to calculate an energy metric associated with estimated energy expenditure for the EV to pickup the new delivery. The dynamic scheduling may then determine whether current charge level of the EV is sufficient to accommodate the energy metric and complete its existing deliveries. If the energy metric is too large (i.e., the EV does not have sufficient charge level to complete its existing deliveries and the new delivery), the dynamic scheduling may determine whether a charging station is proximate the location of the EV, the new delivery, or both and may determine whether to assign the new delivery to the EV based on availability of a charging station or lack thereof.

The exemplary types of feedback described above may be just one of several factors considered during dynamic scheduling in accordance with the present disclosure. For example, while the distance-based and charge level-based techniques described above merely consider a single dimension (e.g., distance, charge level or energy consumption), dynamic scheduling may be performed on a multi-dimensional basis in some implementations. As a non-limiting example, the dynamic scheduling may estimate an amount of delay that will be introduced to the EV's the remaining deliveries if the EV deviates from its planned delivery schedule to attend to the new delivery. If the amount of delay that will occur as a result of assigning the new delivery to the EV is below or equal to the threshold amount of delay, then the EV may be assigned the new delivery and the scheduling data for the EV may be updated with information for the new delivery. If the amount of delay exceeds the threshold amount of delay, the dynamic scheduling will select a next EV and evaluate whether the next EV is better suited for the new delivery.

As another example, parameters of the order associated with the new delivery may be used to perform dynamic scheduling. To illustrate, the order may include parameters that indicate a class of service or pickup time and the dynamic scheduling may determine whether the EV is capable of completing its existing deliveries and the new delivery within the constraints of the parameters of the order, such as after all existing deliveries are completed. In accounting for such order parameters the dynamic scheduling may also account for the charge level of the EV and availability of one or more charging stations (e.g., if the charge level is insufficient to accommodate the new delivery).

Furthermore, the dynamic scheduling may also evaluate the above-described considerations with respect to other EVs of the deployed fleet, as well as non-deployed EVs, and may determine to assign the new delivery to an EV providing optimized handling of the new delivery. For example, a first EV may be within a threshold distance of the new delivery (e.g., based on the current location of the EV or a point along the EVs route for remaining deliveries) and a second EV may not be within the threshold distance of the new delivery. In such a single-dimensional analysis, the first EV would be assigned the new delivery as it is closer by distance.

However, dynamic delivery scheduling in accordance with the present disclosure may consider other factors unique to EVs, such as charge level, which may alter the assignment of the new delivery. To illustrate and continuing with the example above, the dynamic scheduling may receive feedback associated with the charge levels of the first and second EVs and determine that the first EV has insufficient charge to complete its current deliveries and the new delivery while the second EV has sufficient charge to complete its current deliveries and the new delivery. Under these circumstances the new delivery may be assigned to the second EV since the first EV has an insufficient charge level to accommodate all assigned deliveries and the new delivery.

Continuing with the above example, suppose that the dynamic scheduling determines there is a charging station that the first EV could use to charge its power source to a sufficient level to accommodate the new and existing deliveries. Under this scenario is may be ambiguous as to whether it is optimal to assign the new delivery to the first EV, which will need to visit a charging station to complete all deliveries, or the second EV, which will not need to charge to complete all deliveries. Using the multi-factored analysis described above, the dynamic scheduling may compute delay metrics for the first and second EVs to determine whether the new delivery will result in unsatisfactory delays in the remaining deliveries for the first and second EVs. Assuming the delay metrics for the first and second EVs both satisfy the threshold delay, the EV providing the more optimal delivery time (i.e., lowest delay metric) may be assigned the new delivery, resulting in an optimized scheduling of the new delivery and all existing deliveries.

Other types of feedback data may also be used to perform dynamic scheduling of EVs in accordance with the present disclosure. For example, the EVs may include various sensors to monitor components or characteristics of the EV and metrics derived from the sensors (e.g., speed, tire pressure, amount of charge/discharge, duration of charging, distance travelled between charges, etc.) may be provided as feedback to the scheduling system 102. The metrics generated from information collected by the sensors may be used by the scheduling system 102 to provide controls signals and/or dynamic scheduling of EVs in accordance with the concepts disclosed herein. For example, when an EV is charging at a charging station feedback data including metrics derived from the power source (e.g., amount of charge/discharge, duration of charging, distance travelled between charges, output voltage levels, etc.) may be transmitted to the scheduling system 102 and used to determine a state of the power source, such as to evaluate a charge efficiency based on the metrics indicative of the amount of charge/discharge of the power source. As another example, the scheduling system 102 may detect a problem with the power source based on the power source metrics. To illustrate, if the distance travelled between (full) charges of the power source remains relatively uniform over time the power source may be determined to be in good working order, but if it is decreasing (i.e., smaller distances travelled before (full) charges) a problem with the power source may be indicated. When such as problem is detected, the scheduling system 102 may schedule the EV for maintenance, such as to have the power source/system inspected. As another example, feedback data related to the speed of the EV may be used to send a control signal to the EV to slow the EV down, such as if the speed of the EV exceeds a threshold speed, which could indicate a problem with the EV or that the driver is driving the EV in an unsafe manner.

It is noted that various ones of the dynamic scheduling and feedback-based operations described above may be performed using various components and techniques described above with reference to FIGS. 1-6. For example, dynamic scheduling of deliveries may utilize the functionality of adaptive EV scheduling engine 126 of FIG. 1; one or more steps of the method 200 of FIG. 2 may be used to identify new deliveries/orders, verify EV capacity verification, analyze charging requirements, and the like; the order classification engine 130 of FIGS. 1 and 3 may be used to identify orders suitable for dynamic delivery scheduling with respect to deployed or undeployed EVs of the fleet; the vehicle classification and order provisioning engine 132 of FIGS. 1 and 4 may be used to identify deployed EVs suitable for dynamic delivery scheduling (e.g., EVs having volume/weight capacity for a new delivery, new order distance evaluation, etc.); the vehicle order mapping engine 134 of FIGS. 1 and 5 may be used to determine the impact of a dynamic order on delivery times, etc.; and reverse logistics engine 136 of FIGS. 1 and 6 may be used to assign additional orders to EVs. Using the above-described techniques and other functionalities described herein provides for improved operation of EVs within an environment across a variety of dimensions, including reducing energy expenditure, optimizing energy utilization, route optimization planning with charging, reduced delays in delivery, improved operational visibility into fleet performance, dynamic load balancing and rebalancing, and other benefits described herein. Accordingly, it should be understood that the method 700, as well as the various components and functionalities described with reference to FIGS. 1-6 that may be used to support operations of the method 700, provide improvements to various aspects of the disclosed systems, including improvements to EV operations, scheduling system, route planning technology, and power management systems.

In some examples, a device (e.g., the scheduling system 102) for adaptive EV scheduling includes a memory (e.g., the memory 106) and one or more processors (e.g., the one or more processors 104) communicatively coupled to the memory. The one or more processors are configured to initiate, perform, or control one or more operations described with reference to the method 700 of FIG. 7.

In some examples, a non-transitory computer-readable storage medium (e.g., the memory 106) stores instructions (e.g., the instructions 108) that, when executed by one or more processors (e.g., the one or more processors 104), cause the one or more processors to perform operations for adaptive EV scheduling. The operations include one or more operations described with reference to the method 700 of FIG. 7.

Those of skill in the art would understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

One or more components, functional blocks, and modules described herein with respect to FIGS. 1-7 may include processors, electronics devices, hardware devices, electronics components, logical circuits, memories, software codes, firmware codes, among other examples, or any combination thereof. In addition, features discussed herein may be implemented via specialized processor circuitry, via executable instructions, or combinations thereof.

Those of skill would further appreciate that the various illustrative logical blocks, modules, circuits, and algorithm steps described in connection with the disclosure herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure. Skilled artisans will also readily recognize that the order or combination of components, methods, or interactions that are described herein are merely examples and that the components, methods, or interactions of the various aspects of the present disclosure may be combined or performed in ways other than those illustrated and described herein.

The various illustrative logics, logical blocks, modules, circuits, and algorithm processes described in connection with the implementations disclosed herein may be implemented as electronic hardware, computer software, or combinations of both. The interchangeability of hardware and software has been described generally, in terms of functionality, and illustrated in the various illustrative components, blocks, modules, circuits and processes described above. Whether such functionality is implemented in hardware or software depends upon the particular application and design constraints imposed on the overall system.

The hardware and data processing apparatus used to implement the various illustrative logics, logical blocks, modules, and circuits described in connection with the aspects disclosed herein may be implemented or performed with a general purpose single- or multi-chip processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, or any conventional processor, controller, microcontroller, or state machine. In some implementations, a processor may also be implemented as a combination of computing devices, such as a combination of a DSP and a microprocessor, a plurality of microprocessors, one or more microprocessors in conjunction with a DSP core, or any other such configuration. In some implementations, particular processes and methods may be performed by circuitry that is specific to a given function.

In one or more aspects, the functions described may be implemented in hardware, digital electronic circuitry, computer software, firmware, including the structures disclosed in this specification and their structural equivalents thereof, or any combination thereof. Implementations of the subject matter described in this specification also may be implemented as one or more computer programs, that is one or more modules of computer program instructions, encoded on a computer storage media for execution by, or to control the operation of, data processing apparatus.

If implemented in software, the functions may be stored on or transmitted over as one or more instructions or code on a computer-readable medium. The processes of a method or algorithm disclosed herein may be implemented in a processor-executable software module which may reside on a computer-readable medium. Computer-readable media includes both computer storage media and communication media including any medium that may be enabled to transfer a computer program from one place to another. A storage media may be any available media that may be accessed by a computer. By way of example, and not limitation, such computer-readable media can include random-access memory (RAM), read-only memory (ROM), electrically erasable programmable read-only memory (EEPROM), CD-ROM or other optical disk storage, magnetic disk storage or other magnetic storage devices, or any other medium that may be used to store desired program code in the form of instructions or data structures and that may be accessed by a computer. Also, any connection may be properly termed a computer-readable medium. Disk and disc, as used herein, includes compact disc (CD), laser disc, optical disc, digital versatile disc (DVD), floppy disk, hard disk, solid state disk, and Blu-ray disc where disks usually reproduce data magnetically, while discs reproduce data optically with lasers. Combinations of the above should also be included within the scope of computer-readable media. Additionally, the operations of a method or algorithm may reside as one or any combination or set of codes and instructions on a machine readable medium and computer-readable medium, which may be incorporated into a computer program product.

Various modifications to the implementations described in this disclosure may be readily apparent to those skilled in the art, and the generic principles defined herein may be applied to some other implementations without departing from the spirit or scope of this disclosure. Thus, the claims are not intended to be limited to the implementations shown herein, but are to be accorded the widest scope consistent with this disclosure, the principles and the novel features disclosed herein.

Additionally, a person having ordinary skill in the art will readily appreciate, the terms “upper” and “lower” are sometimes used for ease of describing the figures, and indicate relative positions corresponding to the orientation of the figure on a properly oriented page, and may not reflect the proper orientation of any device as implemented.

Certain features that are described in this specification in the context of separate implementations also may be implemented in combination in a single implementation. Conversely, various features that are described in the context of a single implementation also may be implemented in multiple implementations separately or in any suitable subcombination. Moreover, although features may be described above as acting in certain combinations and even initially claimed as such, one or more features from a claimed combination may in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. Further, the drawings may schematically depict one more example processes in the form of a flow diagram. However, other operations that are not depicted may be incorporated in the example processes that are schematically illustrated. For example, one or more additional operations may be performed before, after, simultaneously, or between any of the illustrated operations. In certain circumstances, multitasking and parallel processing may be advantageous. Moreover, the separation of various system components in the implementations described above should not be understood as requiring such separation in all implementations, and it should be understood that the described program components and systems may generally be integrated together in a single software product or packaged into multiple software products. Additionally, some other implementations are within the scope of the following claims. In some cases, the actions recited in the claims may be performed in a different order and still achieve desirable results.

As used herein, including in the claims, various terminology is for the purpose of describing particular implementations only and is not intended to be limiting of implementations. For example, as used herein, an ordinal term (e.g., “first,” “second,” “third,” etc.) used to modify an element, such as a structure, a component, an operation, etc., does not by itself indicate any priority or order of the element with respect to another element, but rather merely distinguishes the element from another element having a same name (but for use of the ordinal term). The term “coupled” is defined as connected, although not necessarily directly, and not necessarily mechanically; two items that are “coupled” may be unitary with each other. the term “or,” when used in a list of two or more items, means that any one of the listed items may be employed by itself, or any combination of two or more of the listed items may be employed. For example, if a composition is described as containing components A, B, or C, the composition may contain A alone; B alone; C alone; A and B in combination; A and C in combination; B and C in combination; or A, B, and C in combination. Also, as used herein, including in the claims, “or” as used in a list of items prefaced by “at least one of” indicates a disjunctive list such that, for example, a list of “at least one of A, B, or C” means A or B or C or AB or AC or BC or ABC (that is A and B and C) or any of these in any combination thereof. The term “substantially” is defined as largely but not necessarily wholly what is specified—and includes what is specified; e.g., substantially 90 degrees includes 90 degrees and substantially parallel includes parallel—as understood by a person of ordinary skill in the art. In any disclosed aspect, the term “substantially” may be substituted with “within [a percentage] of” what is specified, where the percentage includes 0.1, 1, 5, and 10 percent; and the term “approximately” may be substituted with “within 10 percent of” what is specified. The phrase “and/or” means and or.

Although the aspects of the present disclosure and their advantages have been described in detail, it should be understood that various changes, substitutions and alterations can be made herein without departing from the spirit of the disclosure as defined by the appended claims. Moreover, the scope of the present application is not intended to be limited to the particular implementations of the process, machine, manufacture, composition of matter, means, methods and processes described in the specification. As one of ordinary skill in the art will readily appreciate from the present disclosure, processes, machines, manufacture, compositions of matter, means, methods, or operations, presently existing or later to be developed that perform substantially the same function or achieve substantially the same result as the corresponding aspects described herein may be utilized according to the present disclosure. Accordingly, the appended claims are intended to include within their scope such processes, machines, manufacture, compositions of matter, means, methods, or operations.

What is claimed is:

1. A method for adaptive electrical vehicle (EV) scheduling, the method comprising:
receiving, by one or more processors, order data from an order management system, wherein the order data indicates a plurality of deliveries;
receiving, by the one or more processors, vehicle data from a fleet management system, wherein the vehicle data indicates vehicle parameters associated with a plurality of EVs that are included in an EV fleet;
automatically generating, by the one or more processors, vehicle-to-order scheduling data based on the order data, the vehicle data, and one or more EV charging parameters associated with at least one EV of the plurality of EVs, wherein the vehicle-to-order scheduling data indicates a mapping of the plurality of deliveries to the plurality of EVs;
initiating transmission, by the one or more processors, of the vehicle-to-order scheduling data to initiate dispatch of the plurality of EVs for performance of the plurality of deliveries;
receiving, by the one or more processors, feedback data based on the performance of the plurality of deliveries; and
performing, by the one or more processors, one or more operations based on the feedback data.

2. The method of claim 1, wherein the one or more EV charging parameters include one or more of a state of charge (SOC) associated with a battery of the at least one EV, a state of health (SOH) associated with the battery, a location of a charging station for the at least one EV, an average charging duration associated with the at least one EV, or an intelligent charging parameter associated with the at least one EV.

3. The method of claim 2, wherein the intelligent charging parameter indicates an amount of charging to be performed for the at least one EV for a particular delivery of the plurality of deliveries.

4. The method of claim 1, wherein the vehicle-to-order scheduling data is based further on feedback data associated with one or more prior EV scheduling operations.

5. The method of claim 1, wherein the vehicle-to-order scheduling data is based further on mapping data received from a map provider.

6. The method of claim 5, further comprising:
determining, based on the mapping data, a charging station at which an EV of the plurality of EVs is to be charged;
determining, based on the one or more charging parameters, a state of charge (SOC) associated with the EV;
determining, based on the order data, an estimated charge consumption associated with a particular delivery of the plurality of deliveries; and
based on a difference between the SOC and the estimated charge consumption, generating an indication of an amount of charging to be performed for the EV at the charging station, wherein the vehicle-to-order scheduling data includes the indication of the amount of charging.

7. The method of claim 1, wherein the vehicle data indicates a maintenance status indicating whether vehicle maintenance is scheduled for an EV of the plurality of EVs within a particular time frame.

8. The method of claim 7, wherein, based on the maintenance status indicating that no vehicle maintenance is scheduled for the EV within the particular time frame, the EV is assigned, via the vehicle-to-order scheduling data, to a particular delivery of the plurality of deliveries based on a first priority.

9. The method of claim 8, wherein, based on the maintenance status indicating that vehicle maintenance is scheduled for the EV within the particular time frame, the EV is associated with a second priority that is less than the first priority.

10. An apparatus for adaptive electric vehicle (EV) scheduling, the apparatus comprising:
a memory; and
one or more processors communicatively coupled to the memory, the one or more processors configured to:
receive order data from an order management system, wherein the order data indicates a plurality of deliveries;
receive vehicle data from a fleet management system, wherein the vehicle data indicates vehicle parameters associated with a plurality of EVs that are included in an EV fleet;
automatically generate vehicle-to-order scheduling data based on the order data, the vehicle data, and one or more EV charging parameters associated with at least one EV of the plurality of EVs, wherein the vehicle-to-order scheduling data indicates a mapping of the plurality of deliveries to the plurality of EVs;
initiate transmission of the vehicle-to-order scheduling data to initiate dispatch of the plurality of EVs for performance of the plurality of deliveries;
receive feedback data based on the performance of the plurality of deliveries; and
perform one or more operations based on the feedback data.

11. The apparatus of claim 10, wherein the vehicle data indicates a utilization metric associated with an EV of the plurality of EVs.

12. The apparatus of claim 11, wherein, based on the utilization metric failing to exceed a utilization threshold, the one or more processors are further configured to assign the EV, via the vehicle-to-order scheduling data, to a particular delivery of the plurality of deliveries based on a first priority.

13. The apparatus of claim 12, wherein, based on the utilization metric exceeding the utilization threshold, the one or more processors are further configured to associate the EV the EV with a second priority that is less than the first priority.

14. The apparatus of claim 10, wherein the one or more processors are further configured to determine, based on the feedback data, one or more of a recentness metric, a clustering metric, or a delay frequency metric associated with the performance of the plurality of deliveries.

15. The apparatus of claim 14, wherein:
the one or more processors are further configured to determine one or more of the recentness metric, the clustering metric, or the delay frequency metric by inputting a training set to an artificial intelligence (AI)-based factor recalibration engine to train the AI-based factor recalibration engine to determine one or more of the recentness metric, the clustering metric, or the delay frequency metric, and
the one or more operations include one or more of reporting, tracking, or trend analysis based on one or more of the recentness metric, the clustering metric, or the delay frequency metric.

16. A non-transitory computer-readable storage medium storing instructions that, when executed by one or more processors, cause the one or more processors to perform operations for adaptive electric vehicle (EV) scheduling, the operations comprising:
receiving, by the one or more processors, order data from an order management system, wherein the order data indicates a plurality of deliveries;
receiving, by the one or more processors, vehicle data from a fleet management system, wherein the vehicle data indicates vehicle parameters associated with a plurality of EVs that are included in an EV fleet;
automatically generating, by the one or more processors, vehicle-to-order scheduling data based on the order data, the vehicle data, and one or more EV charging parameters associated with at least one EV of the plurality of EVs, wherein the vehicle-to-order scheduling data indicates a mapping of the plurality of deliveries to the plurality of EVs;
initiating transmission, by the one or more processors, of the vehicle-to-order scheduling data to initiate dispatch of the plurality of EVs for performance of the plurality of deliveries;
receiving, by the one or more processors, feedback data based on the performance of the plurality of deliveries; and
performing, by the one or more processors, one or more operations based on the feedback data.

17. The non-transitory computer-readable storage medium of claim 16, wherein the operations further comprise, after assigning a particular EV of the plurality of EVs to a particular delivery of the plurality of deliveries, performing a reverse logistics operation to determine whether the particular EV is to be assigned at least one other delivery of the plurality of deliveries.

18. The non-transitory computer-readable storage medium of claim 17, wherein performing the reverse logistics operation includes:
determining that the particular EV has capacity to perform the at least one other delivery; and
based on determining that the particular EV has the capacity to perform the at least one other delivery, modifying the vehicle-to-order scheduling data to indicate that the particular EV is further assigned the at least one other delivery.

19. The non-transitory computer-readable storage medium of claim 17, wherein performing the reverse logistics operation includes:
determining that the particular EV does not have capacity to perform the at least one other delivery; and
based on determining that the particular EV does not have the capacity to perform the at least one other delivery, completing an assignment for the particular EV.

20. The non-transitory computer-readable storage medium of claim 17, wherein the reverse logistics operation is performed based on one or more of a delivery distance associated with the at least one other delivery, a volume associated with the at least one other delivery, or a weight associated with the at least one other delivery.
